(19) United States
(12) Patent Application Publication
(10) Pub. No.: US 2011/0158621 A1
(43) Pub. Date: Jun. 30, 2011

(54) LENS BARREL

(75) Inventors: Hironori Honsho, Hyogo (JP); Hideo Onishi, Osaka (JP)

(73) Assignee: Panasonic Corporation, Osaka (JP)

(21) Appl. No.: 12/970,970

(22) Filed: Dec. 17, 2010

(30) Foreign Application Priority Data
Dec. 28, 2009 (JP) 2009-297791
Nov. 12, 2010 (JP) 2010-254006

(51) Int. Cl. G03B 17/00

(52) U.S. Cl. 396/55

(57) ABSTRACT

A lens barrel which includes an optical system, a support mechanism, a drive correcting mechanism, a retractable lens frame, and a drive retracting mechanism. The optical system includes a corrective lens group and a retractable lens group. The support mechanism movably supports the corrective lens group in a direction perpendicular to the optical axis of the optical system. The drive correcting mechanism is configured to drives the support mechanism so that the corrective lens group moves in a direction perpendicular to the optical axis of the optical system. The retractable lens frame retractably supports the retractable lens group to a first position in which the optical axis of the retractable lens group is offset from the optical axis of the optical system. The drive retracting mechanism is configured to drive the retractable lens frame so that the retractable lens group retracts to the first position.

### CROSS-REFERENCE TO RELATED APPLICATIONS

This application claims priority under 35 U.S.C. §119 to Japanese Patent Application No. 2009-297791, filed on Dec. 28, 2009 and Japanese Patent Application No. 2010-254006, filed on Nov. 12, 2010. The entire disclosure of Japanese Patent Application No. 2009-297791 and Japanese Patent Application No. 2010-254006 are hereby incorporated herein by reference.

### BACKGROUND

1. Technical Field

The technology disclosed herein relates to a lens barrel.

2. Background Information

In recent years, we have witnessed the growing popularity of digital cameras that make use of a Charge Coupled Device (CCD) or Complementary Metal-Oxide Semiconductor (CMOS) sensor or other such imaging element to convert an optical image into an electrical signal, and digitally record this electrical signal.

With a digital camera such as this, there is a need not only for a higher pixel count in the CCD or CMOS sensor, but also for higher performance in the lens barrel that forms an optical image on these imaging elements. More specifically, there is a need for a high-performance lens barrel in which a high-power zoom lens system is installed and with which blurring during image capture can be corrected. Further, there is a need for a lens barrel that is quiet in operation, has low power consumption, and is capable of high-quality moving picture capture, that is, quiet, extended-time imaging.

Meanwhile, a requirement in the field of digital cameras is for the camera body to be smaller, so that it can be carried around more easily. Accordingly, there is a need to reduce the size of the lens barrel, which is believed to contribute greatly to reducing the size of the camera body.

In view of this, many different lens barrels have been proposed in the past (see, for example, Japanese Laid-Open Patent Application JP2008-46504).

With the lens barrel discussed in JP2008-46504, a retracting lens 10 is retracted to outside the optical path, which reduces the size of the lens barrel in the optical axis direction in its retracted state. With this lens barrel, blur correction is accomplished by moving an imaging element unit 33 in a direction perpendicular to the optical axis by means of a Y actuator 65 and an X actuator 66. This type of blur correction is sometimes called a sensor shift method.

A problem with the sensor shift method, however, is that the actuators are bulkier than with an optical method in which blur correction is performed by moving a correction lens. For example, the imaging element weighs about three times as much as a correction lens. Furthermore, since the imaging element requires numerous signal lines, it must be driven while these signal lines are bent. In particular, in recent years there has been an increase in digital cameras that make use of CMOS image sensors to improve sequential capture performance. Since the number of circuit wires connected to a CMOS image sensor is greater than with a CCD image sensor, the drive load thereof ends up being even greater. For example, when an imaging element is driven, it requires about fives times or more energy as when a correction lens is driven.

Thus, the actuators end up being larger when a sensor shift method is used. Therefore, even though a constitution in which the lens is retracted is employed, it has been difficult to achieve further reductions in the size of a lens barrel.

### SUMMARY

A lens barrel is provides with an optical system, a support mechanism, a drive correcting mechanism, a retractable lens frame, and a drive retracting mechanism. The optical system includes a corrective lens group and a retractable lens group. The support mechanism movably supports the corrective lens group in a direction perpendicular to the optical axis of the optical system. The drive correcting mechanism is configured to drives the support mechanism so that the corrective lens group moves in a direction perpendicular to the optical axis of the optical system. The retractable lens frame retractably supports the retractable lens group to a first position in which the optical axis of the retractable lens group is offset from the optical axis of the optical system. The drive retracting mechanism is configured to drive the retractable lens frame so that the retractable lens group retracts to the first position.

These and other features, aspects and/or advantages of the present invention will become apparent to those skilled in the art from the following detailed description, which, taken in conjunction with the annexed drawings, discloses embodiments of the present invention.

### BRIEF DESCRIPTION OF DRAWINGS

Referring now to the attached drawings which form a part of this original disclosure:

FIG. 1 is a simplified oblique view of a digital camera;

FIG. 2 is a simplified oblique view of a digital camera;

FIG. 3A is a simplified oblique view of a lens barrel in the retracted position, and FIG. 3B is a simplified oblique view of a lens barrel at the wide angle end;

FIG. 4 is an exploded oblique view of a lens barrel;

FIG. 5 is an exploded oblique view of a lens barrel;

FIG. 6 is an exploded oblique view of a lens barrel;

FIG. 7 is an exploded oblique view of a lens barrel;

FIG. 8 is a simplified cross section of a lens barrel in the retracted position;

FIG. 9 is a simplified cross section of a lens barrel at the wide angle end;

FIG. 10 is a simplified cross section of a lens barrel at the telephoto end;

FIG. 11A is an oblique view of a lens barrel at the retracted position, and FIG. 11B is an oblique view of a lens barrel at the wide angle end;

FIG. 12A is an oblique view of a lens barrel at the retracted position, and FIG. 12B is an oblique view of a lens barrel at the wide angle end;

FIG. 13A is an oblique view of a drive frame and rotary cam frame at the retracted position, and FIG. 13B is an oblique view of a drive frame and rotary cam frame at the wide angle end;

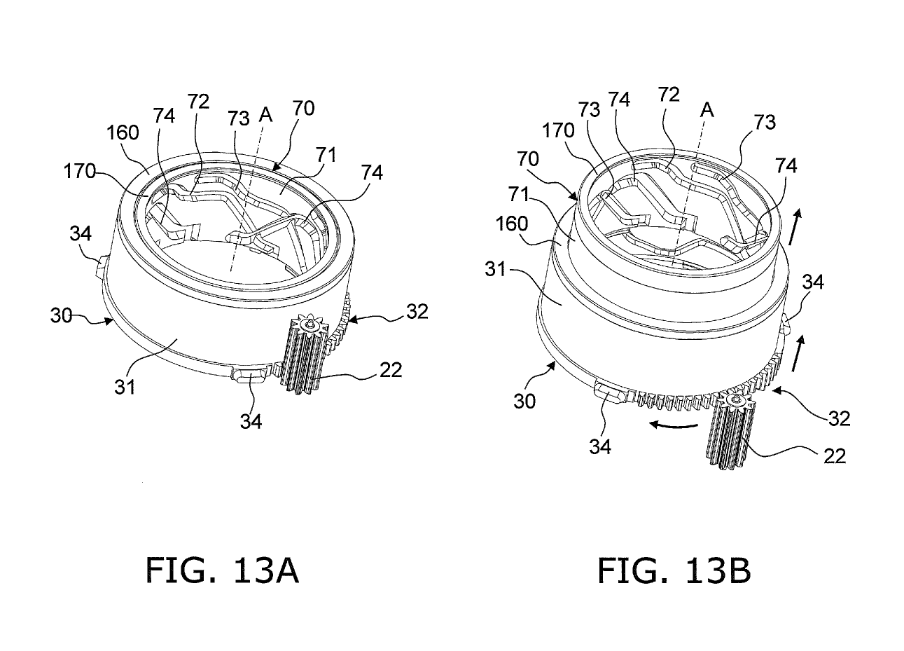

FIG. 14 is an oblique view of a drive frame and rotary cam frame;

FIG. 15 is an oblique view of a rotary cam frame and a camera cam frame;

FIG. 16A is a side view of a rotary cam frame and a camera cam frame, and

FIG. 16B is a plan view of a rotary cam frame and a camera cam frame;

FIG. 17 is an exploded oblique view of a lens barrel;

FIG. 18 is an oblique view of a third lens frame and a camera cam frame;

FIG. 19A is a plan view of a third lens frame in a retracted state, and FIG. 19B is a plan view of a third lens frame in an inserted state;

FIG. 20A is a cross section of a third lens frame in a retracted state, and FIG. 20B is a cross section of a third lens frame in an inserted state;

FIG. 21 is an oblique view of a retraction lens frame and a rectilinear frame;

FIG. 22 is an exploded oblique view of a third lens frame;

FIG. 23A is a simplified diagram of the configuration of an optical system at the wide angle end, and FIG. 23B is a simplified diagram of the configuration of an optical system at the retracted position;

FIG. 24 is a simplified cross section of a lens barrel at the retracted position;

FIG. 25 is a simplified cross section of a lens barrel at the wide angle end;

FIG. 26 is a simplified cross section of a lens barrel at the telephoto end;

FIG. 27 is an exploded oblique view of a lens barrel;

FIG. 28 is an exploded oblique view of a lens barrel;

FIG. 29 is an exploded oblique view of a second lens frame;

FIG. 30A is a cross section illustrating the positional relation between a retraction lens frame and a second lens frame, and FIG. 30B is a plan view illustrating the positional relation between a retraction lens frame and a second lens frame;

FIG. 31A is an assembly diagram for a second lens frame in a state in which a second retraction lens frame is attached to a second lens frame body, and FIG. 31B is an assembly diagram for a second lens frame in a state in which a leaf spring is attached to a second lens frame body;

FIG. 32A is a diagram illustrating when a second lens group does not retract, and FIG. 32B is a diagram illustrating when a second lens group retracts;

FIG. 33A is a simplified diagram of the configuration of an optical system at the wide angle end, and FIG. 33B is a simplified diagram of the configuration of an optical system at the retracted position;

FIG. 34A is a simplified diagram of the configuration of an optical system at the wide angle end, and FIG. 34B is a simplified diagram of the configuration of an optical system at the retracted position;

FIG. 35A is a simplified diagram of the configuration of an optical system at the wide angle end, and FIG. 35B is a simplified diagram of the configuration of an optical system at the retracted position;

FIG. 36A is a simplified diagram of the configuration of an optical system at the wide angle end, and FIG. 36B is a simplified diagram of the configuration of an optical system at the retracted position; and

FIG. 37A is a simplified diagram of the configuration of an optical system at the wide angle end, and FIG. 37B is a simplified diagram of the configuration of an optical system at the retracted position.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

### 1: Overview of Digital Camera

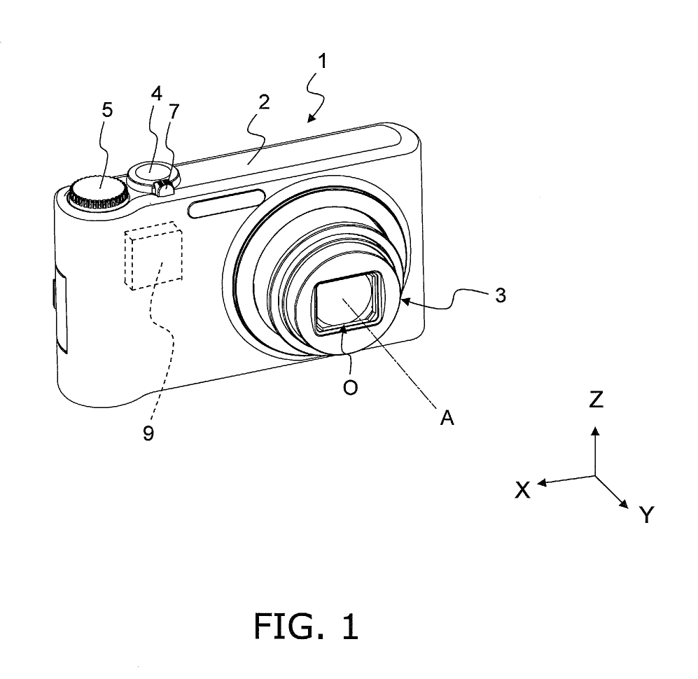

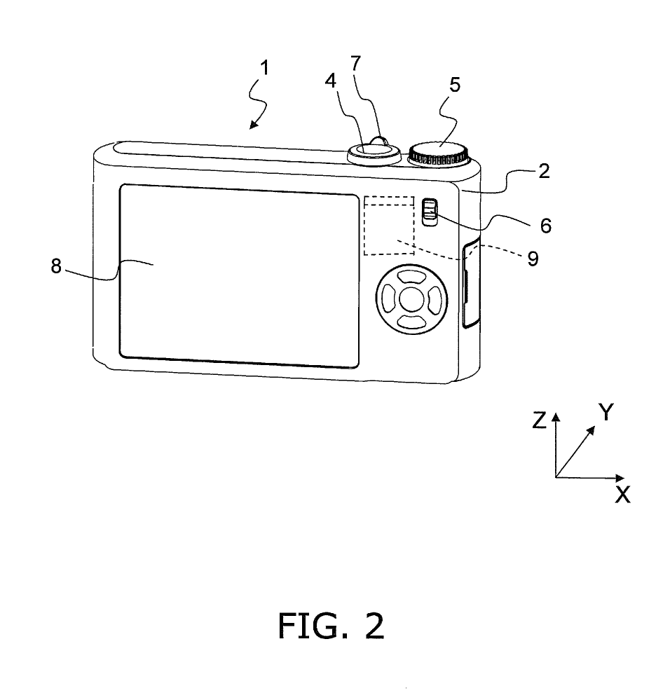

A digital camera 1 will be described through reference to FIGS. 1 and 2. FIGS. 1 and 2 are simplified oblique views of the digital camera 1. FIG. 1 shows the case when a lens barrel 3 is in its imaging state (wide angle end).

The “wide angle end” referred to here indicates a state in which the focal length of an optical system O (discussed below) is at its shortest, and the “telephoto end” indicates a state in which the focal length of the optical system O is at its longest. A state when the power is on is defined as an imaging state, and a state in which the lens barrel 3 is at its shortest length with the power off is defined as a stowed state. In this embodiment, the imaging state corresponds to the wide angle end state of the optical system O.

The digital camera 1 is a camera used to acquire an image of a subject. A multi-stage telescoping lens barrel 3 is installed in the digital camera 1 in order to afford a higher zoom ratio and reduce the size.

In the following description, the six sides of the digital camera 1 are defined as follows.

The side facing the subject when an image is being captured by the digital camera 1 is called the front face, and the face on the opposite side is called the rear face. When an image is captured such that up and down in the vertical direction of the subject coincide with up and down in the short-side direction of the rectangular image being captured by the digital camera 1 (the aspect ratio (the ratio of long to short sides) is generally 3:2, 4:3, 16:9, etc.), the side facing upward in the vertical direction is called the top face, and the opposite side is called the bottom face. Further, when an image is captured such that up and down in the vertical direction of the subject coincide with up and down in the short-side direction of the rectangular image being captured by the digital camera 1, the side that is on the left when viewed from the subject side is called the left face, and the opposite side is called the right face. The above definitions are not intended to limit the usage orientation of the digital camera 1.

Based on the above definitions, FIG. 1 is an oblique view illustrating the front face, top face, and right face.

The same definitions apply not only to the six sides of the digital camera 1, but also to the six sides of the various constituent members disposed in and on the digital camera 1. Specifically, the above definitions apply to the six sides of the various constituent members in the state in which they have been disposed in or on the digital camera 1.

As shown in FIG. 1, a three-dimensional perpendicular coordinate system is defined, having a Y axis perpendicular to the optical axis A of the optical system O (discussed below). Based on this definition, the direction facing the front face side from the rear face side along the optical axis A is called the Y axis direction positive side, the direction facing the left face side from the right face side perpendicular to the optical axis A is called the X axis direction positive side, and the direction facing the top face side from the bottom face side and perpendicular to the X and Y axes is called the Z axis direction positive side.

### 2: Overall Configuration of Digital Camera

As shown in FIGS. 1 and 2, the digital camera 1 mainly comprises a housing 2 that houses various units, and the lens barrel 3.

The optical system O included in the lens barrel 3 is made up of a plurality of lens groups, and a plurality of lens groups are disposed in a state of being aligned in the Y axis direction. The lens barrel 3 is a multi-stage telescoping type (more specifically, it is a three-stage telescoping type in which three kinds of frame are deployed in the Y axis direction from a fixed frame 20 (discussed below) that serves as a reference), and is supported by the housing 2. The plurality of lens groups are supported by the lens barrel 3 to be movable with respect to the lens barrel 3 in the Y axis direction. The constitution of the lens barrel 3 will be described in detail below.

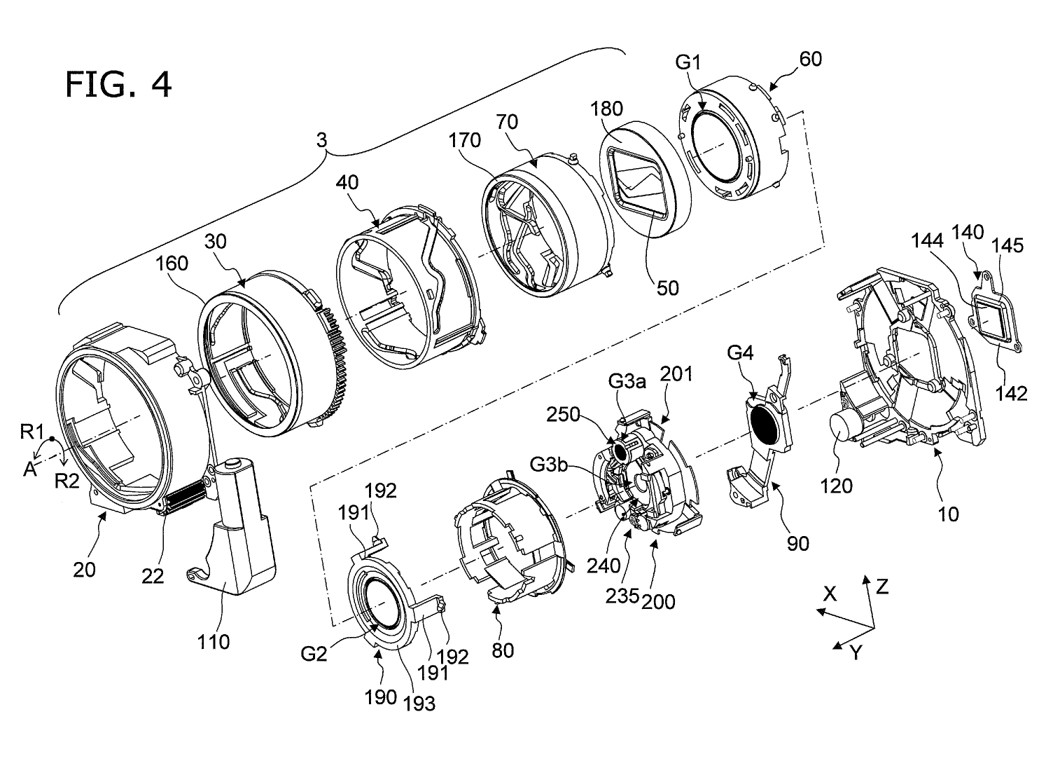

The housing 2 contains a CCD image sensor 141 (an example of an imaging element; see FIG. 4) that performs opto-electrical conversion on an optical image, and an image recorder (not shown) that records images acquired by the CCD image sensor 141. As shown in FIG. 2, a liquid crystal monitor 8 that displays images acquired by the CCD image sensor 141 is arranged on the rear face of the housing 2.

A release button 4, a control dial 5, and a zoom adjusting lever 7 are arranged on the top face of the housing 2. A power switch 6 is arranged on the rear face of the housing 2. The release button 4 is used by the user to input the exposure timing. The control dial 5 is used by the user to make various settings related to imaging operation. The power switch 6 is used by the user to turn the digital camera 1 on or off. The zoom adjusting lever 7 is used by the user to adjust the zoom ratio, and is rotatable around the release button 4 within a specific angular range.

A sensor 9 that detects shake in the pitch direction (rotation around the X axis) and the yaw direction (rotation around the Z axis) of the digital camera 1 is built into the housing 2 to correct image blur (discussed below).

### 3: Configuration of Optical System and Lens Barrel

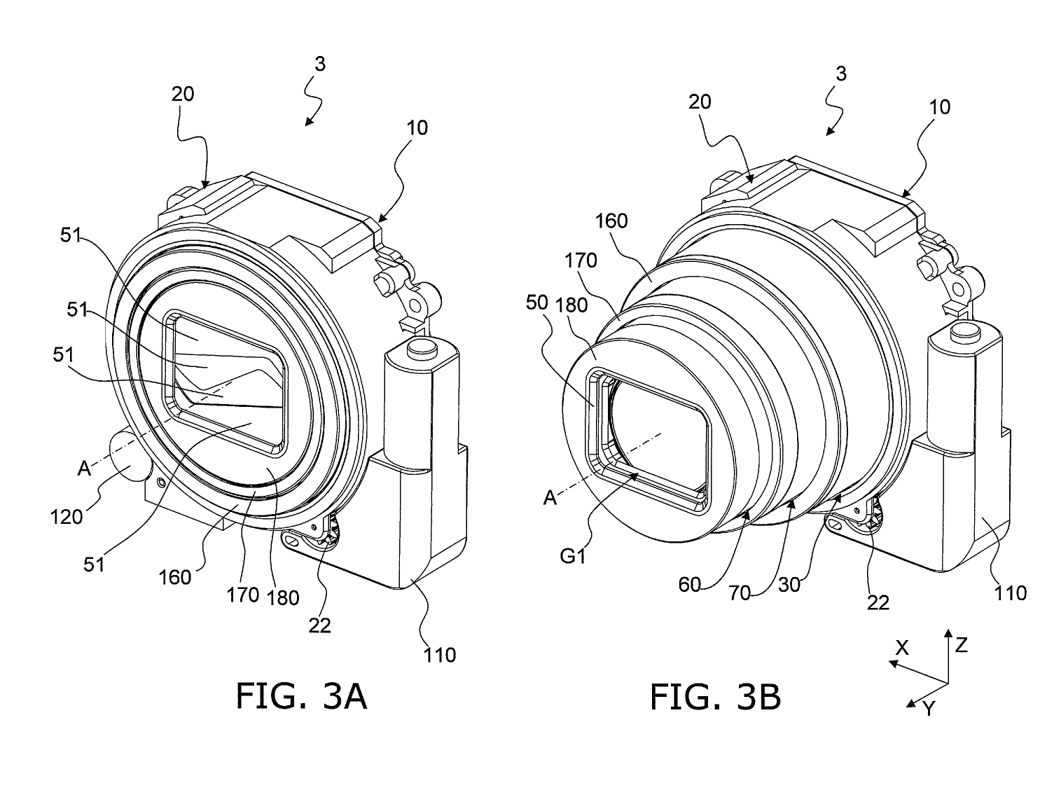

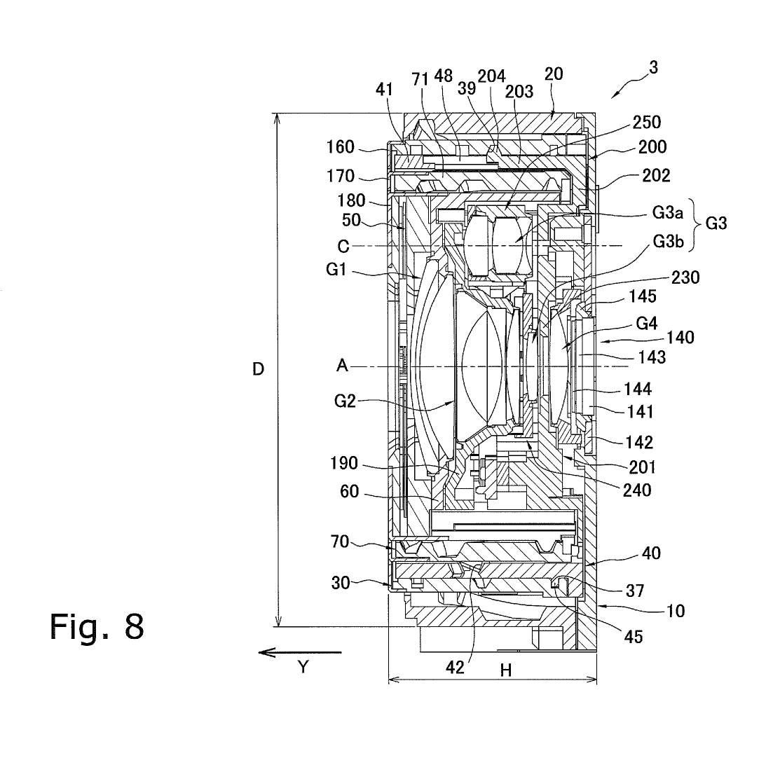

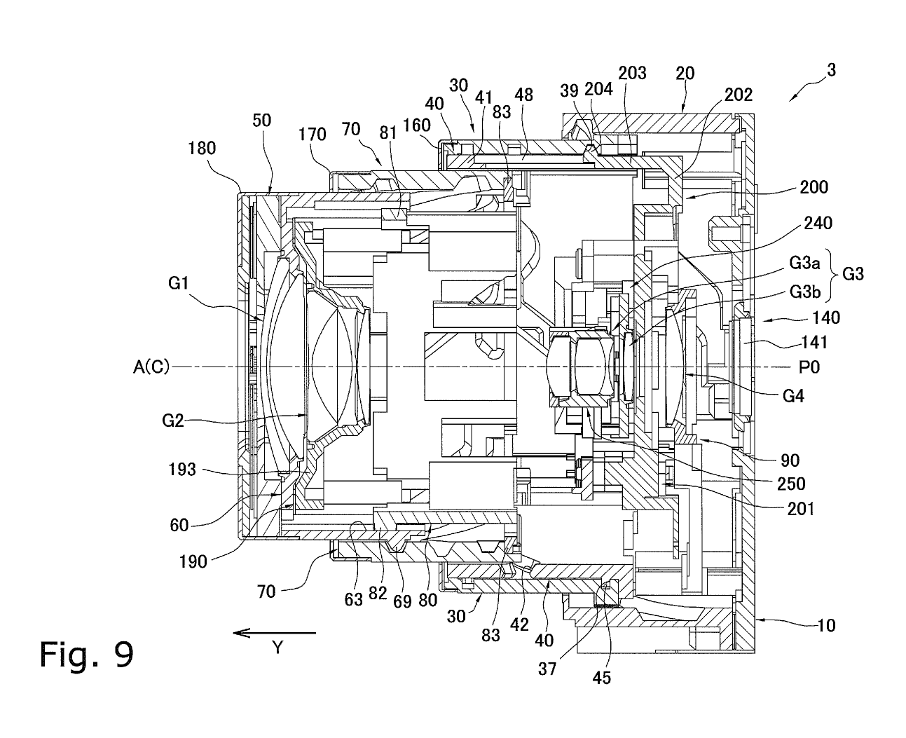

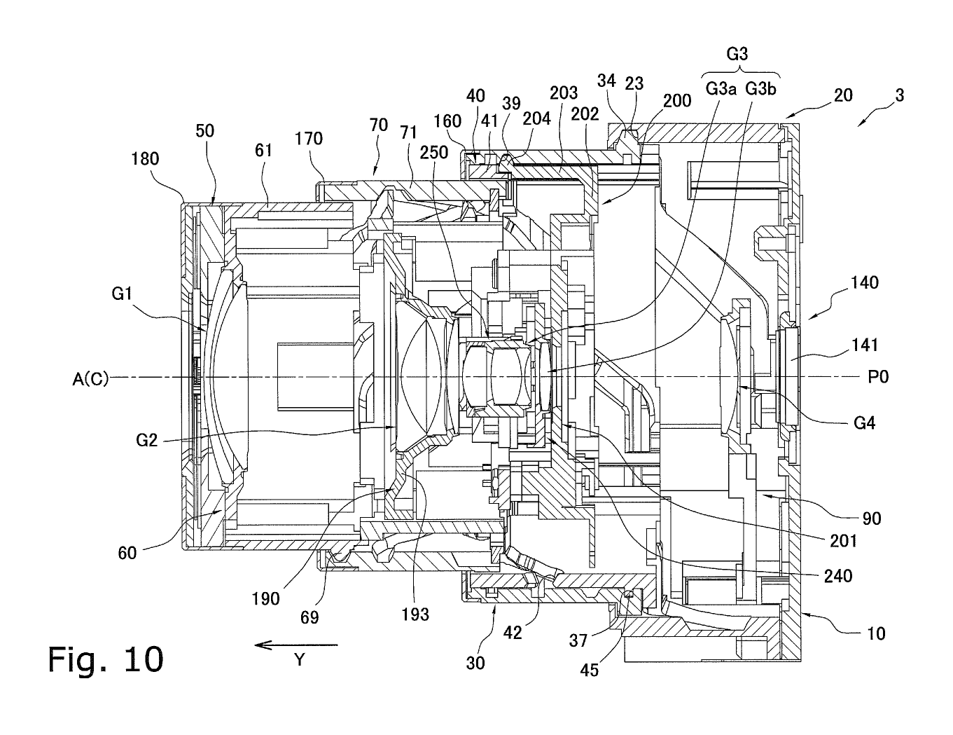

The overall configuration of the lens barrel 3 will be described through reference to FIGS. 3 to 10. FIGS. 3A and 3B are simplified oblique views of the lens barrel 3, and FIGS. 4 to 7 are exploded oblique views of the lens barrel 3. FIG. 3A is a simplified oblique view of the lens barrel 3 when retracted (when stowed), and FIG. 3B is a simplified oblique view of the lens barrel 3 during imaging. FIGS. 8 to 10 are simplified cross sections of the lens barrel 3. FIG. 8 is a cross section of the retracted position, FIG. 9 is a cross section at the wide angle end, and FIG. 10 is a cross section at the telephoto end.

As shown in FIGS. 3 to 5, the lens barrel 3 comprises the optical system O that forms an optical image of a subject, the fixed frame 20 that is fixed to the housing 2, a zoom motor unit 110 serving as a drive source that is fixed to the fixed frame 20, a master flange 10 that holds the various frames between itself and the fixed frame 20, a drive frame 30 to which the drive force of the zoom motor unit 110 is inputted, a camera cam frame 40 supported by the fixed frame 20 movably in the Y axis direction, a rotary cam frame 70 that rotates along with the drive frame 30, and a rectilinear frame 80 that moves in the Y axis direction without rotating with respect to the fixed frame 20. The drive frame 30 and the rotary cam frame 70 are movable in the Y axis direction and to rotate with respect to the fixed frame 20, but the other members move in the Y axis direction without rotating with respect to the fixed frame 20. The CCD image sensor 141 is attached to the master flange 10. An example of the zoom motor unit 110 is a unit made up of a DC motor and a reduction gear.

The lens barrel 3 further comprises a first lens frame 60 that supports a first lens group G1, a second lens frame 190 that supports a second lens group G2, a retraction lens frame 250 that supports a retractable lens group G3a, a correction lens frame 210 that supports an image blur correction lens group G3b, a third lens frame 200 that supports the retraction lens frame 250 and the correction lens frame 210, and a fourth lens frame 90 that supports a fourth lens group G4.

3.1: Optical System

As shown in FIGS. 8 to 10, the optical system O comprises the first lens group G1, the second lens group G2 (an example of a shift lens group), the third lens group G3 made up of the retractable lens group G3a and the correction lens group G3b (an example of a corrective lens group), and the fourth lens group G4. The first lens group G1 is a lens group that has positive power overall, for example, and takes in light from the subject. The second lens group G2 is a lens group that has negative power overall, for example. The zoom ratio of the optical system O can be adjusted with the first lens group G1 and the second lens group G2. The correction lens group G3b and/or the retractable lens group G3a can be constituted by, for example, either a single lens or a plurality of lenses. The correction lens group G3b is a lens group for suppressing movement of the optical image with respect to the CCD image sensor 141 attributable to movement of the digital camera 1, for example. The fourth lens group G4 is a lens group for adjusting the focus point, for example.

3.2: Fixed Frame

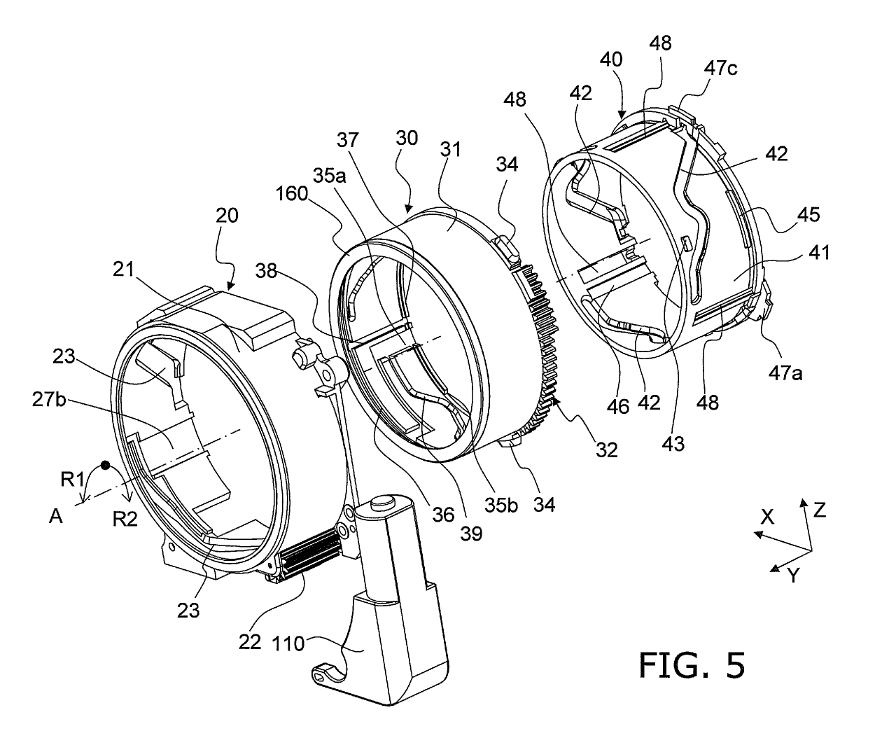

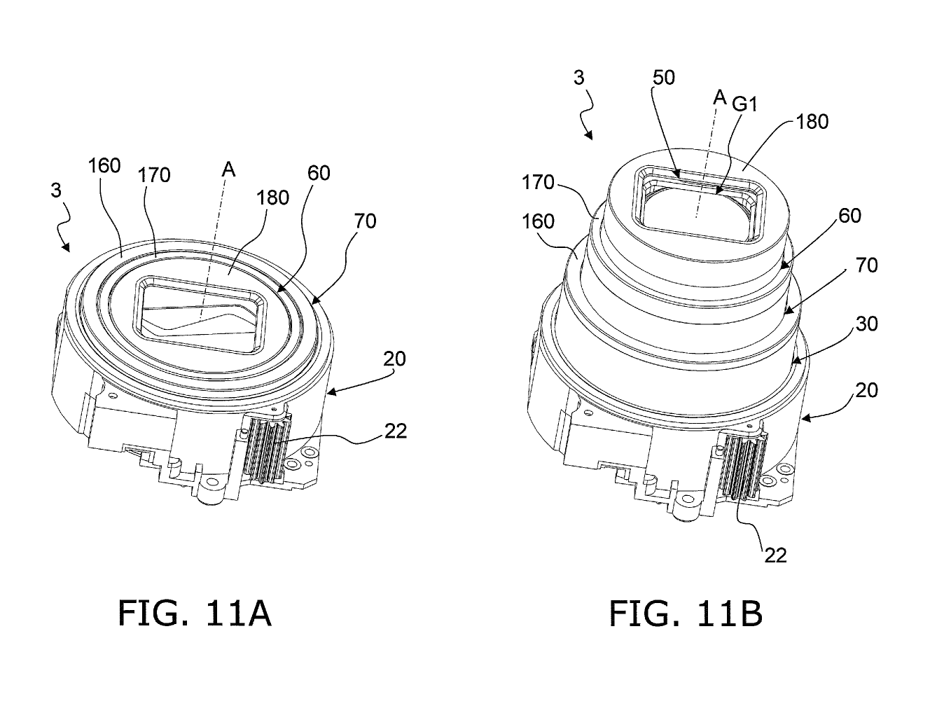

As shown in FIG. 5, the fixed frame 20 is a member used to support the drive frame 30 rotatably around the optical axis A and movably in the Y axis direction (the rectilinear direction), and constitutes the stationary-side member of the lens barrel 3 along with the master flange 10. As shown in FIG. 8, in a retracted state the fixed frame 20 holds in its interior the optical system O (such as the correction lens group G3b and the retractable lens group G3a), and the various frames that support the optical system O. The fixed frame 20 is screwed to the master flange 10, for example. The fixed frame 20 mainly comprises a substantially cylindrical fixed frame body 21 that constitutes the main component, and a drive gear 22 (see FIG. 11) that is rotatably supported by the fixed frame body 21.

The fixed frame body 21 is fixed to the master flange 10, and the drive frame 30 is disposed on the inner peripheral side. The drive gear 22 is a member that is used to transmit the drive force of the zoom motor unit 110 to the drive frame 30, and meshes with a gear (not shown) of the zoom motor unit 110.

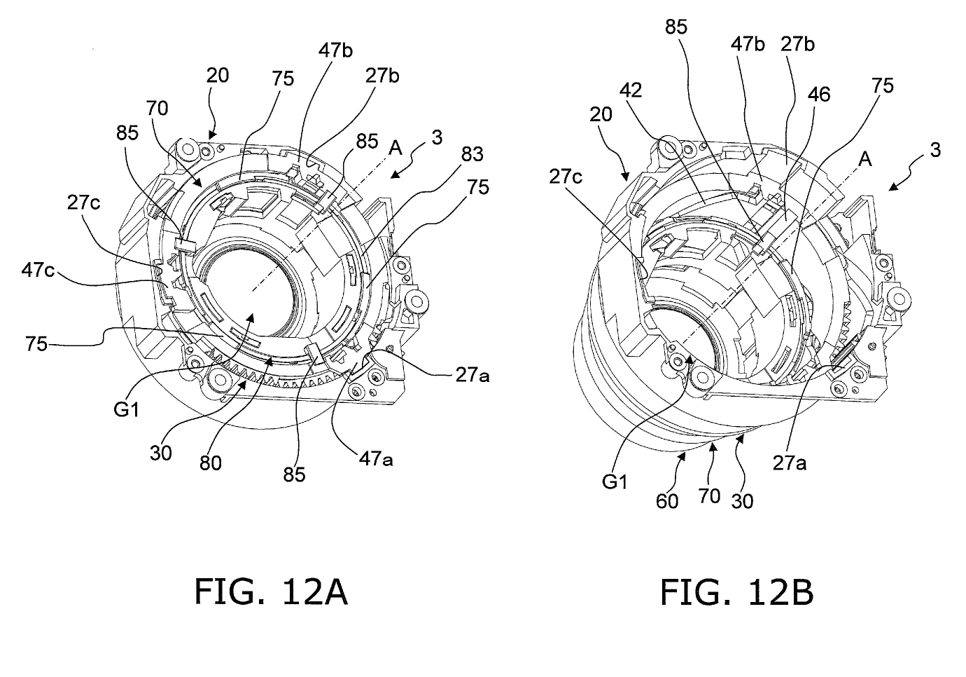

Three cam grooves 23 and three rectilinear grooves 27a, 27b, and 27c (see FIGS. 12A and 12B) are formed on the inner peripheral side of the fixed frame body 21. The cam grooves 23 are used to guide the drive frame 30. The rectilinear grooves 27a, 27b, and 27c are used to guide the camera cam frame 40 in the Y axis direction, and accept the insertion of rectilinear projections 46a, 46b, and 46c (discussed below) (see FIG. 12A).

Cam followers 34 (discussed below) of the drive frame 30 are inserted into the cam grooves 23, and are disposed at a substantially constant pitch in the circumferential direction.

3.3: Drive Frame

As shown in FIGS. 4 and 5, the drive frame 30 is a member used to support the camera cam frame 40 rotatably around the optical axis A and movably and integrally in the Y axis direction, and is disposed on the inner peripheral side of the fixed frame 20. The rotary drive from the zoom motor unit 110 is inputted to the drive frame 30, and the drive force is transmitted through the drive frame 30 to other members.

The drive frame 30 mainly has a substantially cylindrical drive frame body 31 that is disposed on the inner peripheral side of the fixed frame body 21, a gear 32 formed on the outer peripheral side of the drive frame body 31, and the three cam followers 34 formed on the outer peripheral side of the drive frame body 31. The drive frame body 31 is disposed between the fixed frame 20 and the camera cam frame 40 (discussed below) in the radial direction. A cosmetic ring 160 is attached to the end of the drive frame body 31 on the Y axis direction positive side. A light blocking ring (not shown) in the form of a thin, hollow disk is sandwiched between the cosmetic ring 160 and the drive frame body 31.

The gear 32 meshes with the drive gear 22 of the fixed frame 20. Consequently, the drive force of the zoom motor unit 110 is transmitted through the drive gear 22 to the drive frame 30. The three cam followers 34 are disposed at a substantially constant pitch in the circumferential direction. The cam followers 34 are fitted into the cam grooves 23 of the fixed frame 20. Consequently, the drive frame 30 moves in the Y axis direction while rotating around the optical axis A with respect to the fixed frame 20.

As shown in FIG. 5, a first rotary groove 36, a second rotary groove 37, three guide grooves 35a, three guide grooves 35b, three rectilinear grooves 38, and three cam grooves 39 are formed on the inner peripheral side of the drive frame body 31. The first rotary groove 36 guides first rotary projections 43 (discussed below) of the camera cam frame 40 in the rotational direction. The second rotary groove 37 is disposed on the Y axis direction negative side of the first rotary groove 36, and guides second rotary projections 45 (discussed below) of the camera cam frame 40 in the rotational direction. The guide grooves 35a serve to guide the first rotary projections 43 to the first rotary groove 36, and the guide grooves 35b serve to guide the second rotary projections 45 to the second rotary groove 37, and these guide grooves are linked to the first rotary groove 36 and the second rotary groove 37. The three guide grooves 35a and the three guide grooves 35b are disposed at a substantially constant pitch in the circumferential direction, and extend in the Y axis positive direction. The rectilinear grooves 38 serve to guide cam followers 76 (discussed below) of the rotary cam frame 70, and accept the insertion of the ends of the cam followers 76. The rectilinear grooves 38 are disposed between the guide grooves 35a and 35b in the circumferential direction. The three rectilinear grooves 38 are disposed at a substantially constant pitch in the circumferential direction.

The drive frame 30 is driven around the optical axis A (the rotational directions on the R1 and R2 sides) by the drive force of the zoom motor unit 110. For example, when changing from the retracted state to the imaging state, the drive frame 30 is driven to the R2 side by the zoom motor unit 110. As a result, the cam followers 34 move along the cam grooves 23 of the fixed frame 20. Consequently, the drive frame 30 moves to the Y axis direction positive side while rotating with respect to the fixed frame 20.

In changing from an imaging state to a retracted state, the drive frame 30 is driven to the R1 side by the zoom motor unit 110. As a result, the cam followers 34 of the drive frame 30 move along the cam grooves 23. Consequently, the drive frame 30 moves to the Y axis direction negative side while rotating with respect to the fixed frame 20, and the drive frame 30 is housed on the inner peripheral side of the fixed frame 20.

3.4: Camera Cam Frame

As shown in FIGS. 4, 5, 14, 15, and 16, the camera cam frame 40 is a member that serves to guide the rotary cam frame 70 (discussed below) in the optical axis direction with respect to the fixed frame 20, and is disposed on the inner peripheral side of the drive frame 30. The camera cam frame 40 mainly has a substantially cylindrical camera cam frame body 41 that constitutes the main component, three cam through-grooves 42 formed in the camera cam frame body 41, three rectilinear projections 47a to 47c formed on the outer peripheral side of the camera cam frame body 41, and three flanges 44.

The camera cam frame body 41 is disposed between the fixed frame 20 and the rotary cam frame 70 in the radial direction. The three cam through-grooves 42 are disposed at a constant pitch in the circumferential direction. The cam through-grooves 42 are such that the cam followers 76 of the rotary cam frame 70 pass through in the radial direction.

The three rectilinear projections 47a to 47c protrude outward in the radial direction from the end of the camera cam frame body 41 on the Y axis direction negative side, and are disposed at a substantially constant pitch in the circumferential direction. As shown in FIGS. 12A and 12B, the rectilinear projections 47a to 47c are inserted into the rectilinear grooves 27a, 27b, and 27c of the fixed frame 20, and are guided in the Y axis direction by the rectilinear grooves 27a to 27c. The rectilinear projections 47a to 47c and the rectilinear grooves 27a to 27c allow the camera cam frame 40 to move in the Y axis direction without rotating with respect to the fixed frame 20.

The flanges 44 link the two adjacent rectilinear projections 47a and 47b, the two adjacent rectilinear projections 47b and 47c, and the two adjacent rectilinear projections 47c and 47a in the circumferential direction. The flanges 44, along with the rectilinear projections 47a to 47c, form an annular portion that protrudes outward in the radial direction from the camera cam frame body 41. The rectilinear projections 47a to 47c protrude farther outward in the radial direction than the flanges 44. The flanges 44 raise the overall strength of the camera cam frame 40.

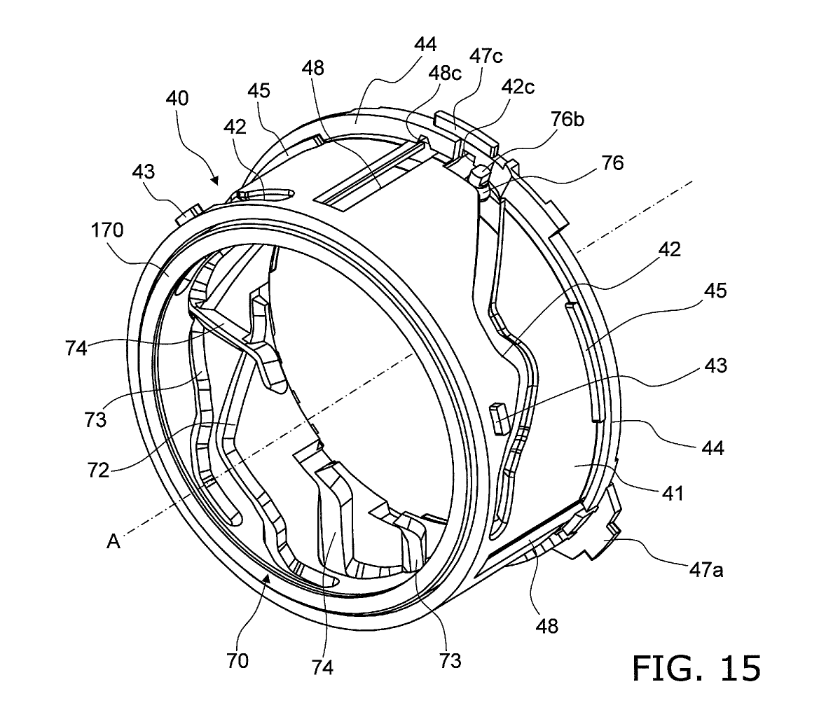

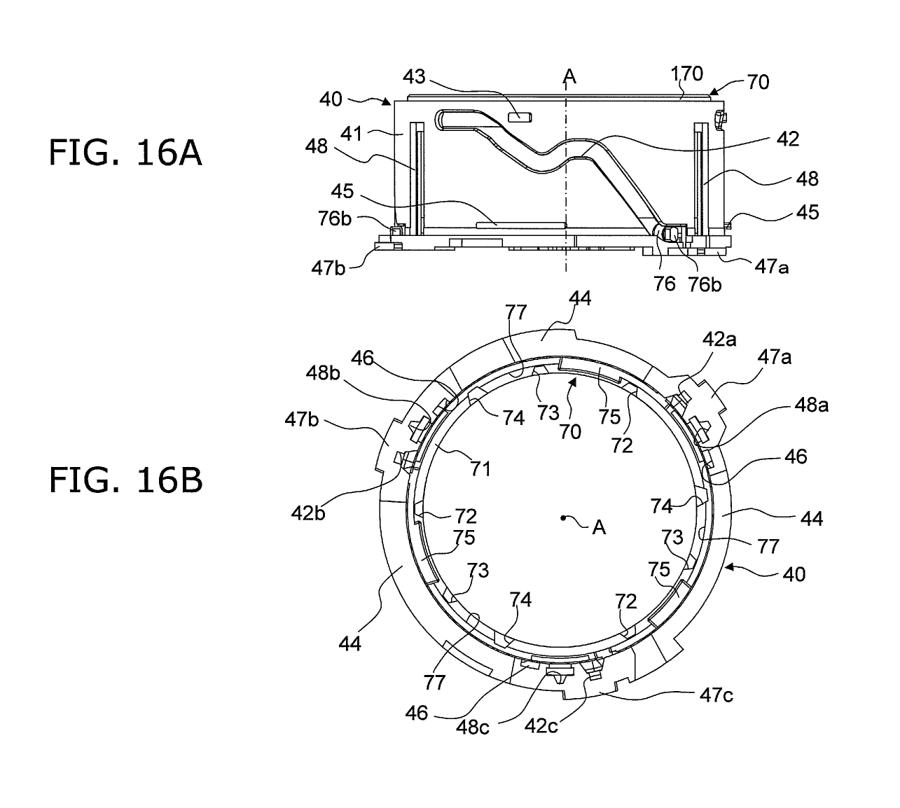

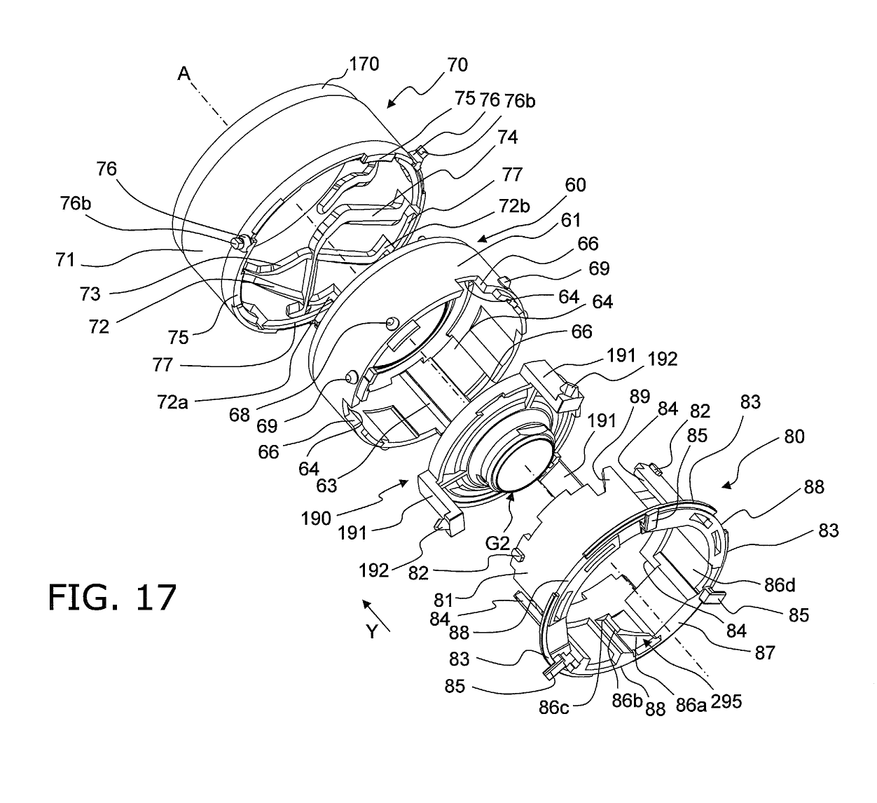

Also, as shown in FIGS. 15 and 16B, the camera cam frame 40 has insertion openings 42a to 42c disposed at positions corresponding to the rectilinear projections 47a to 47c. The three insertion openings 42a to 42c are openings disposed communicating with the cam through-grooves 42, and spread outward in the radial direction beyond the cam followers 76. Also, the size of the rectilinear projections 47a to 47c in the circumferential direction is greater than the size of the insertion openings 42a to 42c in the circumferential direction.

Three first rotary projections 43 and three second rotary projections 45 are formed on the outer peripheral side of the camera cam frame body 41. The first rotary projections 43 and the second rotary projections 45 are positioning projections, and are guided in the rotational direction by the first rotary groove 36 and the second rotary groove 37 of the drive frame 30. Consequently, the camera cam frame 40 rotates with respect to the drive frame 30 as needed while moving integrally with the drive frame 30 in the Y axis direction.

When the drive frame 30 rotates with respect to the fixed frame 20, the drive frame 30 moves in the Y axis direction with respect to the fixed frame 20. At this point the camera cam frame 40 moves in the Y axis direction with respect to the fixed frame 20 along with the drive frame 30 without rotating with respect to the fixed frame 20 (that is, while rotating with respect to the drive frame 30).

Three rectilinear grooves 46 are formed on the inner peripheral side of the camera cam frame body 41. Second rectilinear projections 85 of the rectilinear frame 80 (discussed below) are inserted into the rectilinear grooves 46. Consequently, the rectilinear frame 80 is restricted in the rotational direction with respect to the camera cam frame, and is movable in the Y axis direction.

Three rectilinear through-grooves 48 that pass through from the inner peripheral side to the outer peripheral side of the camera cam frame body 41 are formed in the camera cam frame body 41. Rectilinear projections 203 of the third lens frame 200 (discussed below) are inserted into the rectilinear through-grooves 48. Insertion openings 48a to 48c that guide the rectilinear projections 203 to the rectilinear through-grooves 48 are formed near the three rectilinear protrusions 47a to 47c at the end of the camera cam frame 40 on the Y axis direction negative side. The rectilinear projections 203 of the third lens frame 200 are rotationally restricted by the rectilinear through-grooves 48, and are movable in the Y axis direction.

3.5: First Lens Frame

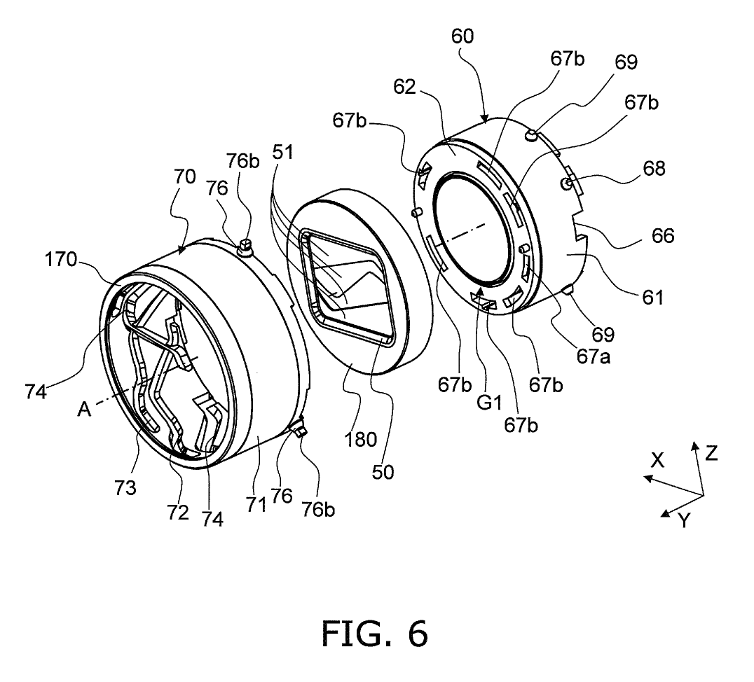

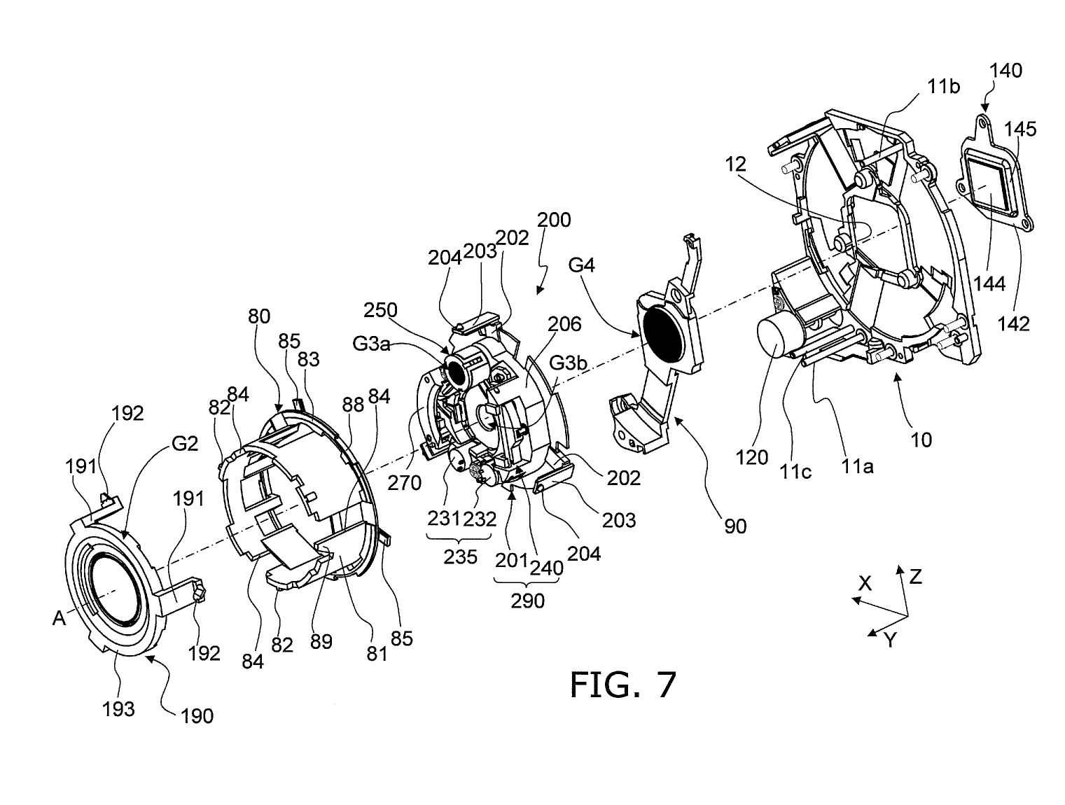

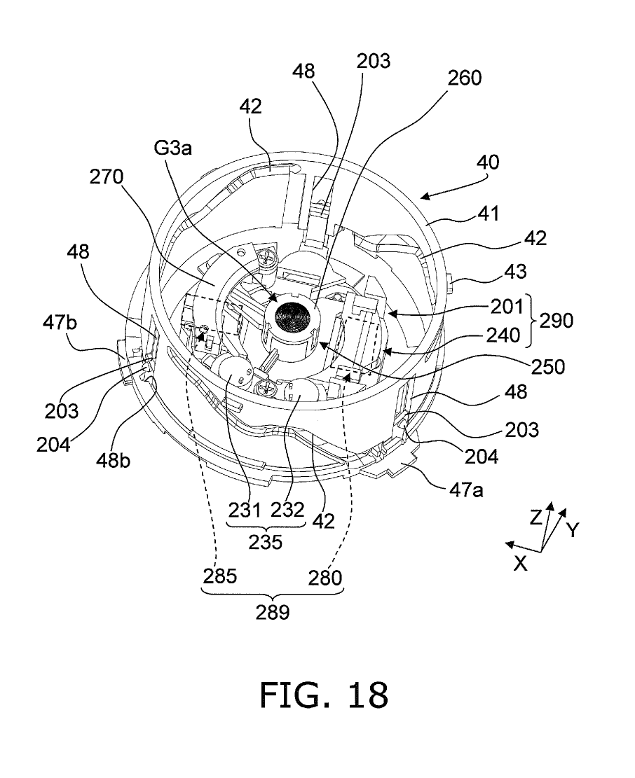

As shown in FIGS. 4, 6, 8, and 17, the first lens frame 60 is a member that is used to support the first lens group G1, and is disposed on the inner peripheral side of the camera cam frame 40. More specifically, the first lens frame 60 mainly has a first lens frame body 61 and a flange 62 to which the first lens group G1 is fixed. The flange 62 is arranged at the end of the first lens frame body 61 on the Y axis direction positive side. One first opening 67a and six second openings 67b that pass through in the Y axis direction are formed in the flange 62. A shutting lever (not shown) of a lens barrier 50 is inserted into the first opening 67a to be movable in the rotational direction during retraction. The lens barrier 50 is fixed on the Y axis direction positive side of the first lens frame 60. As shown in FIG. 6, the lens bather 50 and the first lens frame 60 are covered by a cosmetic ring 180. Three cut-outs 66 are formed at the end of the first lens frame body 61 on the Y axis direction negative side. As shown in FIGS. 7 and 17, the cut-outs 66 are formed to avoid the cam followers 192 of the second lens frame 190 (discussed below) during retraction.

As shown in FIG. 17, three first rectilinear grooves 63 and three second rectilinear grooves 64 are arranged on the inner peripheral side of the first lens frame body 61. Three first cam followers 68 and three second cam followers 69 are arranged on the outer peripheral side of the first lens frame body 61.

The second rectilinear grooves 64 are escape grooves for the escape of rectilinear projections 191 arranged on the outer periphery of the second lens frame 190 (discussed below). The first rectilinear grooves 63 are guided by first rectilinear projections 82 of the rectilinear frame 80 (discussed below). Consequently, the first lens frame 60 moves in the Y axis direction without rotating with respect to the rectilinear frame 80. Specifically, the first lens frame 60 is supported by the rectilinear frame 80 and the camera cam frame 40 so that it can move in the Y axis direction without rotating with respect to the fixed frame 20.

As shown in FIGS. 6 and 17, the first cam followers 68 are mainly positioning pins, and the second cam followers 69 are mainly reinforcing pins. The first cam followers 68 are guided by first cam grooves 72 (discussed below) of the rotary cam frame 70. The second cam followers 69 are inserted into second cam grooves 73 (discussed below) of the rotary cam frame 70 with a gap in between.

Consequently, the first lens frame 60 is supported by the rotary cam frame 70 so that it can move in the Y axis direction while rotating with respect to the rotary cam frame 70.

3.5.1: Configuration of First Rectilinear Grooves 63, Second Rectilinear Grooves 64, First Cam Followers 68, and Second Cam Followers 69

The second rectilinear grooves 64, second rectilinear grooves 64, first cam followers 68, and second cam followers 69 will now be described. As shown in FIG. 17, the first cam followers 68 and the second cam followers 69 are formed integrally with the first lens frame body 61, and protrude outward in the radial direction from the first lens frame body 61. The first rectilinear grooves 63 and the second rectilinear grooves 64 are disposed on the inside of the first lens frame body 61 in the radial direction.

The first cam grooves 72 and second cam grooves 73 of the rotary cam frame 70 have the same shape, but the first cam followers 68 and second cam followers 69 protrude in different amounts from the first lens frame body 61. More specifically, the first cam followers 68 protrude more to the outside in the radial direction than the second cam followers 69. Therefore, the first cam followers 68 butt against the first cam grooves 72, but a gap is ensured between the second cam followers 69 and the second cam grooves 73 in the rotational direction and in the radial direction, and basically there is no contact between the second cam followers 69 and the second cam grooves 73. Since the gap between the second cam followers 69 and the second cam grooves 73 is tiny, if the first lens frame body 61 or the rotary cam frame 70 deforms elastically, it is possible for the second cam followers 69 and the second cam grooves 73 to come into contact.

Thus, positioning of the first lens frame 60 with respect to the camera cam frame 40 is performed solely by the first cam followers 68 and the first cam grooves 72. However, if the user should drop the digital camera 1, for example, then the impact can be borne by the second cam followers 69 in addition to the first cam followers 68. Accordingly, the impact of the drop can be distributed to the first cam followers 68 and the second cam followers 69, which prevents damage to the first cam followers 68 and the second cam followers 69. Furthermore, providing the second cam pins 69 and the second cam grooves 73 prevents the first cam followers 68 and the second cam followers 69 from coming out of the first cam grooves 72 and the second cam grooves 73 of the rotary cam frame 70 in the event that the lens barrel 3 is subjected to a large external force.

3.6: Rotary Cam Frame

As shown in FIG. 17, the rotary cam frame 70 is a member that is used to support the first lens frame 60 and the second lens frame 190 movably in the Y axis direction, and is disposed on the inner peripheral side of the fixed frame 20 and on the outer peripheral side of the first lens frame 60. More specifically, as shown in FIGS. 6, 14, and 17, the rotary cam frame 70 mainly has a substantially cylindrical cam frame body 71, the three cam followers arranged on the outer peripheral side of the cam frame body 71, and three rotary projections 75 on the end of the cam frame body 71 on the Y axis direction negative side. The three cam followers 76 are disposed at a constant pitch in the circumferential direction.

As shown in FIGS. 12A, 12B, 14, and 17, the rotary projections 75 formed integrally with the cam frame body 71 protrude inward in the radial direction from rotary grooves 77. The rotary projections 75 are guided by three introduction grooves 88 of the rectilinear frame 80, rotary projections 83 are sandwiched between the rotary projections 75 and the rotary grooves 77, and the rotary projections 83 are restricted in the Y axis direction with respect to the rotary cam frame 70.

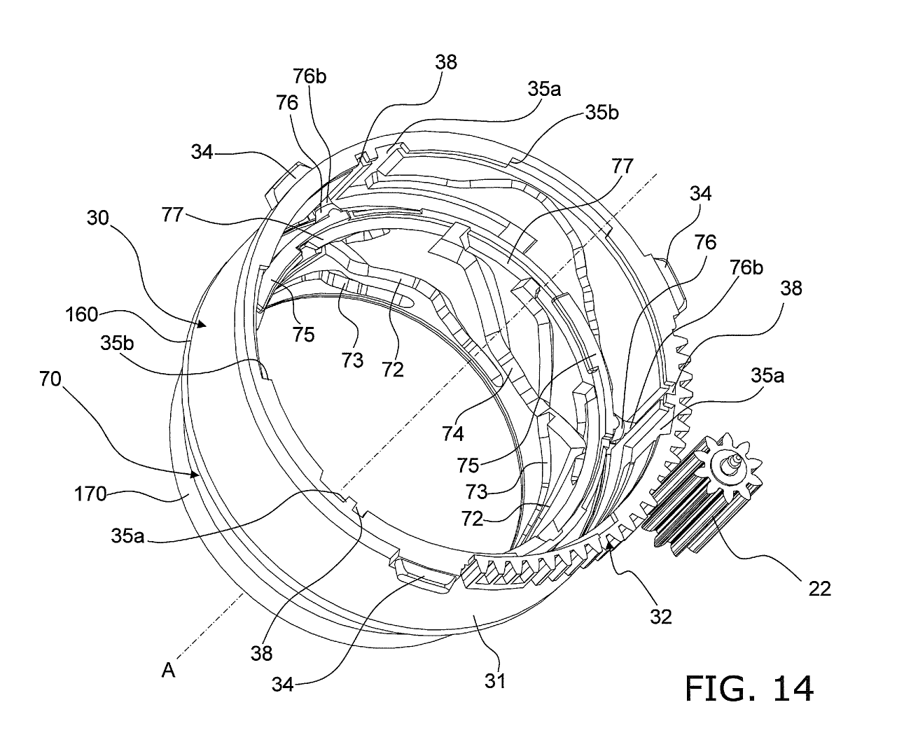

Since the distal ends 76b of the cam followers 76 are inserted into the rectilinear grooves 38 of the drive frame 30 (see FIG. 14), the rotary cam frame 70 is movable in the Y axis direction with respect to the drive frame 30 while rotating integrally with the drive frame 30. Also, since the cam followers 76 pass through the cam through-grooves 42 of the camera cam frame 40, when the drive frame 30 and the camera cam frame 40 rotate relatively, the rotary cam frame 70 and the camera cam frame 40 also rotate relatively. At this point the cam followers 76 move along the cam through-grooves 42, and as a result, the rotary cam frame 70 moves in the Y axis direction with respect to the drive frame 30 according to the shape of the cam through-grooves 42 while rotating along with the drive frame 30.

With the above configuration, the rotary cam frame 70 is movable in the Y axis direction with respect to the drive frame 30 and to rotate integrally with the drive frame 30. Specifically, the rotary cam frame 70 is movable in the Y axis direction while rotating with respect to the fixed frame 20. The amount of movement of the rotary cam frame 70 in the Y axis direction is the sum of the amount of movement of the drive frame 30 in the Y axis direction with respect to the fixed frame 20, and the amount of movement of the rotary cam frame 70 in the Y axis direction with respect to the drive frame 30.

Also, as discussed above, since the first lens frame 60 is supported by the rotary cam frame 70, the amount of movement of the first lens frame 60 in the Y axis direction with respect to the fixed frame 20 is the sum of further adding the amount of movement of the first lens frame 60 in the Y axis direction with respect to the rotary cam frame 70 to the amount of movement of the rotary cam frame 70 in the Y axis direction.

3.6.1: Configuration of First Cam Grooves 72, Second Cam Grooves 73, and Third Cam Grooves 74

As shown in FIGS. 6 and 17, three first cam grooves 72, three second cam grooves 73, and three third cam grooves 74 are formed on the inner peripheral side of the cam frame body 71. The first cam grooves 72 are supported movably with respect to the cam frame body 71, with the first cam followers 68 inserted therein. The second cam grooves 73 are mainly reinforcing cam grooves, and the second cam followers 69 are inserted therein. The three first cam grooves 72 are disposed at a constant pitch in the circumferential direction, and the three second cam grooves 73 are disposed at a constant pitch in the circumferential direction. The shape of the second cam grooves 73 is the same as that of the first cam grooves 72.

With this configuration, when the rotary cam frame 70 rotates with respect to the first lens frame 60, the first cam followers 68 are guided by the first cam grooves 72. As a result, the first lens frame 60 moves in the Y axis direction with respect to the rotary cam frame 70.

Also, since the cam followers 192 (discussed below) of the second lens frame 190 are inserted into the third cam grooves 74, when the rotary cam frame 70 rotates with respect to the second lens frame 190, the cam followers 192 are guided by the third cam grooves 74. As a result, the second lens frame 190 moves in the Y axis direction with respect to the rotary cam frame 70.

3.7: Rectilinear Frame

As shown in FIGS. 7, 12A, 12B, and 17, the rectilinear frame 80 has a rectilinear frame body 81, a flange 87 arranged on the Y axis direction negative side of the rectilinear frame body 81 and protrudes more to the outer peripheral side than the rectilinear frame body 81, three second rectilinear projections 85, three introduction grooves 88, and three rotary projections 83. The rectilinear frame 80 is disposed between the first lens frame 60 and the second lens frame 190 (discussed below) in the radial direction.

The three first rectilinear projections 82 are arranged on the outer peripheral part of the rectilinear frame body 81, and protrude outward in the radial direction from the rectilinear frame body 81. The three first rectilinear projections 82 are disposed at a constant pitch in the circumferential direction, and are inserted into the respective first rectilinear grooves 63 of the first lens frame 60. The second rectilinear projections 85 protrude outward in the radial direction from the flange 87, and are formed integrally with the flange 87, at the end of the flange 87 on the Y axis direction negative side. The second rectilinear projections 85 are inserted into the rectilinear grooves 46 of the camera cam frame 40. Consequently, the rectilinear frame 80 is movable in the Y axis direction without rotating with respect to the camera cam frame 40.

Rectilinear grooves 84 are through-grooves that pass through in the radial direction, and extend in the Y axis direction. Three rectilinear grooves 84 are disposed at a substantially constant pitch in the circumferential direction. Three rectilinear projections 191 of the second lens frame 190 (discussed below) are inserted into the rectilinear grooves 84.

The first rectilinear projections 82, the second rectilinear projections 85, and the rectilinear grooves 84 allow the first lens frame 60 and the second lens frame 190 to move in the Y axis direction with respect to the rectilinear frame 80 without rotating with respect to the rectilinear frame 80. Specifically, the first lens frame 60 and the second lens frame 190 are movable in the Y axis direction without rotating with respect to the fixed frame 20.

Three introduction grooves 88 are formed between the three rotary projections 83 in the circumferential direction. The rotary projections 75 of the rotary cam frame 70 are guided, and the rotary projections 83 are inserted into the rotary grooves 77. The rotary grooves 77 and the rotary projections 75 allow the rotary cam frame 70 to move integrally in the Y axis direction and to rotate with respect to the rectilinear frame 80.

An inclined projection 89 functions as a drive projection for pushing the shutting lever (not shown) of the lens barrier 50 in the rotational direction, and for rotating the shutting lever at the retracted position where the lens barrier 50 and the rectilinear frame 80 are closest together in the Y axis direction, shutting barrier vanes 51.

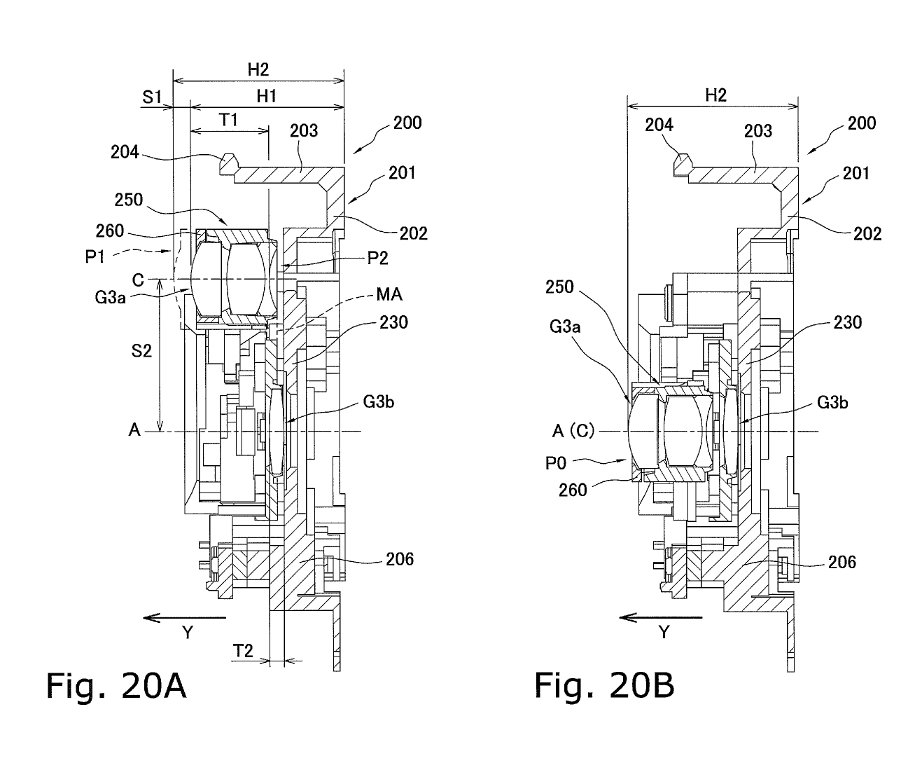

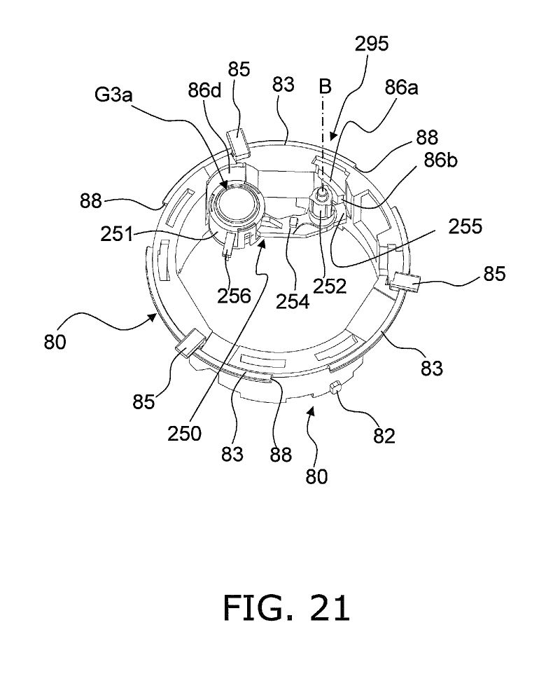

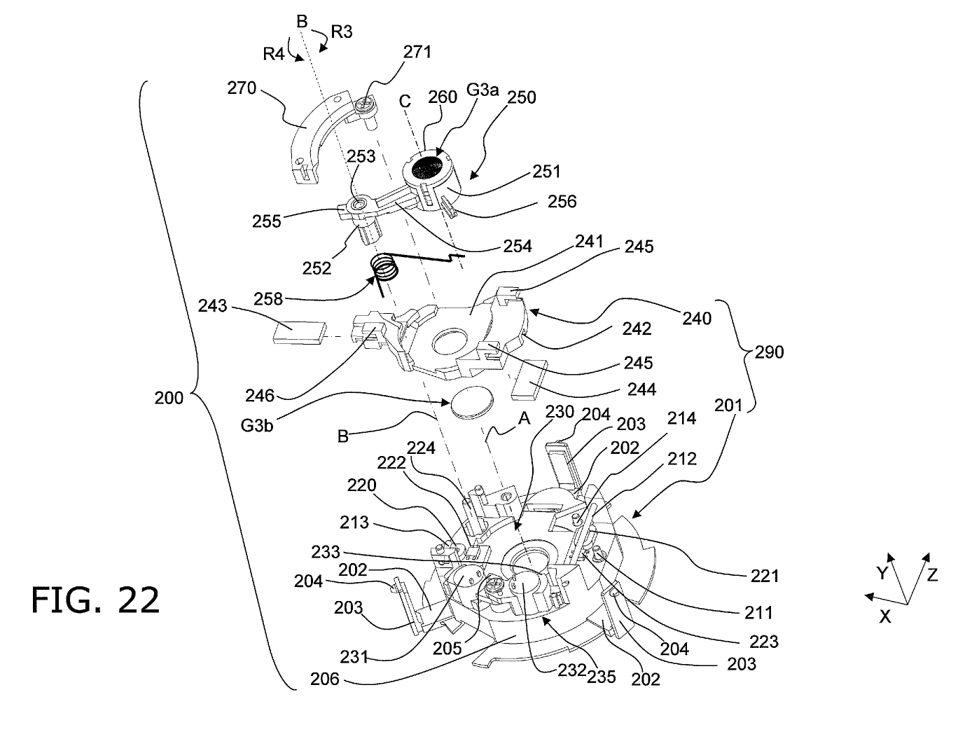

FIG. 19A is a plan view of the retracted state of the retraction lens frame 250, and FIG. 19B is a plan view of the retraction lens frame 250 in the imaging state. FIGS. 20A and 20B are cross sections of the retracted state and imaging state of the retraction lens frame 250, respectively. FIG. 21 is an oblique view of the retraction lens frame 250 and the rectilinear frame 80. As shown in FIGS. 17 and 21, an inclined face 86a, a rectilinear restriction face 86b, an end face 86c, a concave portion 86d are arranged on the inner peripheral side of the rectilinear frame body 81. The inclined face 86a is a cam face that rotates a drive projection 255 of the retraction lens frame 250 (discussed below) to the R3 side the R4 side. For example, when the lens barrel 3 changes from its retracted state to its imaging state, the inclined face 86a rotates the drive projection 255 to the R3 side. When the lens barrel 3 changes from its imaging state to its retracted state, the inclined face 86a rotates the drive projection 255 to the R4 side. The rectilinear restriction face 86b rotates the drive projection 255 further to the R4 side, and retracts the retractable lens group G3a of the retraction lens frame 250 to the retracted position (see FIGS. 19A and 20A). The end face 86c drives the drive projection 255 to the Y axis direction negative side. The concave portion 86d is provided to prevent interference between the retraction lens frame 250 and the rectilinear frame 80, and has a shape that conforms to the lens frame body 251 of the retraction lens frame 250. When the retraction lens frame 250 retracts, part of the lens frame body 251 goes into the concave portion 86d.

3.8: Second Lens Frame

The second lens frame 190 is a member for supporting the second lens group G2 movably in the Y axis direction, and is disposed on the inner peripheral side of the rectilinear frame 80. More specifically, as shown in FIGS. 7 and 17, the second lens frame 190 mainly has a second lens frame body 193 that supports the second lens group G2, three rectilinear projections 191 formed on the outer peripheral part of the second lens frame body 193, and three cam followers 192 arranged on the outer peripheral side of the rectilinear projections 191.

The rectilinear projections 191 are flat projections that extend in the Y axis direction, and are disposed at positions corresponding to the rectilinear grooves 84 of the rectilinear frame 80. The three rectilinear projections 191 are disposed at a substantially constant pitch in the circumferential direction. The rectilinear grooves 84 and the rectilinear projections 191 allow the second lens frame 190 to move in the Y axis direction without rotating with respect to the rectilinear frame 80.

The cam followers 192 protrude outward in the radial direction from the ends of the rectilinear projections 191 (more precisely, the ends on the Y axis direction negative side). The cam followers 192 are fitted into the third cam grooves 74 of the rotary cam frame 70.

With the above configuration, the second lens frame 190 is movable in the Y axis direction according to the shape of the third cam grooves 74, without rotating with respect to the fixed frame 20.

3.9: Third Lens Frame

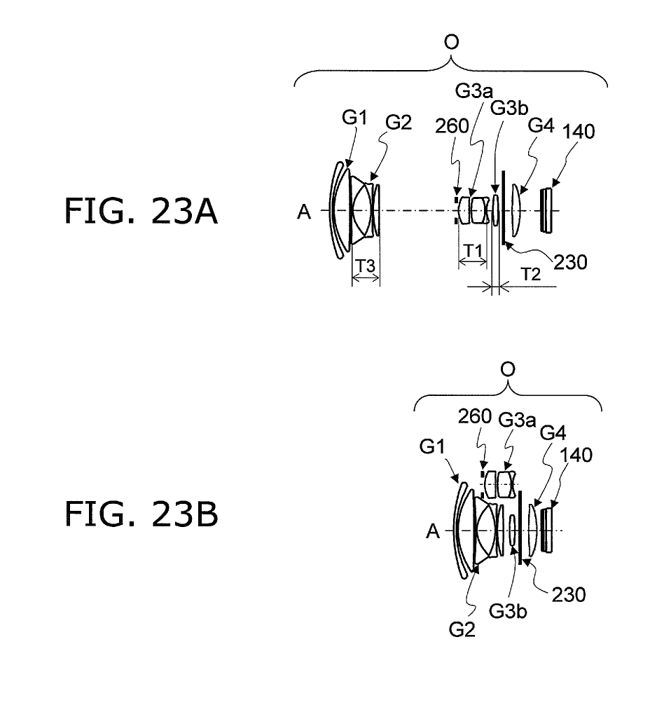

The third lens frame 200 is disposed on the inner peripheral side of the rectilinear frame 80, and constitutes a blur correction device for suppressing movement of the optical image with respect to the CCD image sensor 141 caused by movement of the housing 2. The third lens frame 200 is movable overall in the Y axis direction with respect to the fixed frame 20, and supports the third lens group G3 movably in a plane perpendicular to the optical axis. More specifically, as shown in FIGS. 7, 19A, 19B, and 22, the third lens frame 200 mainly has a base frame 201, the retraction lens frame 250 that supports the retractable lens group G3a, a correction lens frame 240 that supports the correction lens group G3b, a retraction main axis cover 270, and a torsion compression coil spring 258. The base frame 201 and the correction lens frame 240 constitute a correction lens support mechanism 290 (one example of a support mechanism) that supports the correction lens group G3b movably in a direction perpendicular to the optical axis A (see FIG. 22). Since the third lens frame 200 is disposed movably in the Y axis direction with respect to the fixed frame 20, that means the correction lens support mechanism 290 is disposed movably in the Y axis direction with respect to the fixed frame 20.

The base frame 201 has a substantially cylindrical base frame body 206, three arms 202 that extend outward in the radial direction from the outer peripheral part of the base frame body 206, three rectilinear projections 203 that extend to the Y axis direction positive side from the ends of the three arms 202, three cam followers 204 that protrude outward in the radial direction from the outer peripheral part of the rectilinear projections 203, a rotary shaft 211, a restrictor shaft 214, a first support shaft 212, and a second support shaft 213. The rectilinear projections 203 are flat projections that extend in the Y axis direction, and are inserted into the rectilinear through-grooves 48 of the camera cam frame 40. The cam followers 204 are fitted into the cam grooves 39 of the drive frame 30.

The rotary shaft 211, the restrictor shaft 214, the first support shaft 212, and the second support shaft 213 are fixed to the base frame 201. The rotary shaft 211 supports the correction lens frame 240 rotatably around the axis of the rotary shaft 211. The restrictor shaft 214 restricts the movement range of the correction lens frame 240 with respect to the base frame 201 (more precisely, the movement range in the X axis direction and the Z axis direction perpendicular to the optical axis A), and is inserted into a restricting portion 247 formed in a support frame body 241 (see FIGS. 19A and 19B).

The first support shaft 212 and the second support shaft 213 support the correction lens frame 240 movably in a plane perpendicular to the optical axis A, and restrict the movement range of the correction lens frame 240 in the Y axis direction with respect to the base frame 201. The ends of the first support shaft 212 are fixed to the base frame body 206. The second support shaft 213 is shorter than the first support shaft 212, and one end of the second support shaft 213 is fixed to the base frame body 206.

The correction lens frame 240 is supported by the base frame 201 movably in the pitch direction (such as the X axis direction) and the yaw direction (such as the Z axis direction). More specifically, the correction lens frame 240 has the support frame body 241, a first guide portion 242, a pair of second guide portions 245, a third guide portion 246, and the restricting portion 247. The correction lens group G3b is fixed to the correction lens frame 240.

The first guide portion 242 is a slender groove extending in the X axis direction. The rotary shaft 211 is inserted into the first guide portion 242. The first guide portion 242 and the rotary shaft 211 allow the correction lens frame 240 to move in the X axis direction and to rotate around the center of the rotary shaft 211 with respect to the third lens frame 200.

The pair of second guide portions 245 are L-shaped portions that slide with the first support shaft 212, and protrude in the X axis direction from the base frame 201. The pair of second guide portions 245 are disposed spaced apart in the Z axis direction. The first support shaft 212 is inserted between the support frame body 241 and the second guide portions 245. The second guide portions 245 and the first support shaft 212 restrict the movement of the correction lens frame 240 in the Y axis direction with respect to the third lens frame 200.

The third guide portion 246 is an L-shaped portion that slides with the second support shaft 213. The second support shaft 213 is inserted between the support frame body 241 and the third guide portion 246. The third guide portion 246 and the second support shaft 213 restrict the movement of the correction lens frame 240 in the Y axis direction with respect to the third lens frame 200.

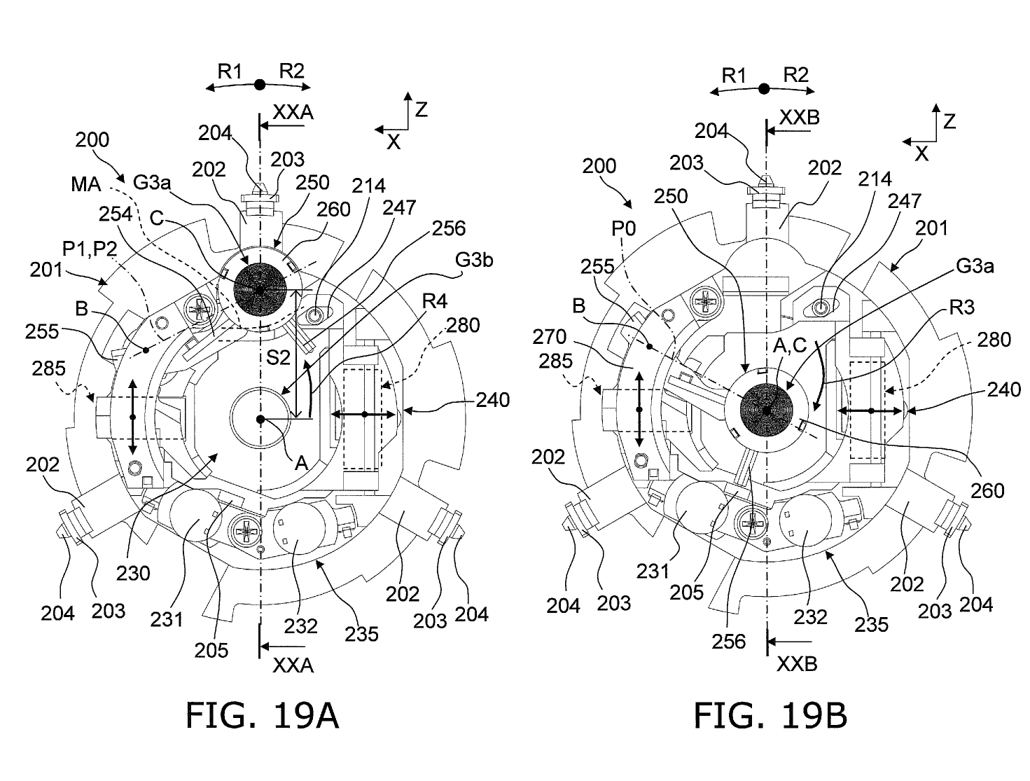

A pitch drive unit 280 (one example of a first drive correcting unit) and a yaw drive unit 285 (one example of a second drive correcting unit) are arranged on the third lens frame 200. The pitch drive unit 280 and the yaw drive unit 285 constitute a drive correcting mechanism 289 (see FIG. 18) that drives the correction lens support mechanism 290 (more precisely, that drives the correction lens frame 240 with respect to the base frame 201).

The pitch drive unit 280 drives the correction lens support mechanism 290 so that the correction lens group G3b moves in a pitch direction perpendicular to the optical axis A (an example of a first direction). More specifically, as shown in FIG. 22, the pitch drive unit 280 has a pitch coil 221, a pitch magnet 244, and a pitch position sensor 223. In this embodiment, the pitch coil 221 is fixed to the base frame 201, and the pitch magnet 244 is adhesively fixed, for example, to the correction lens frame 240. The pitch position sensor 223 is fixed to the base frame 201.

The yaw drive unit 285 drives the correction lens support mechanism 290 so that the correction lens group G3b moves in a yaw direction perpendicular to the optical axis A (the Z axis direction; an example of a second direction). More specifically, as shown in FIG. 22, the yaw drive unit 285 has a yaw coil 220, a yaw magnet 243, and a yaw position sensor 222. In this embodiment, the yaw coil 220 is fixed to the base frame 201, and the yaw magnet 243 is adhesively fixed, for example, to the correction lens frame 240. The yaw position sensor 222 is fixed to the base frame 201.

As shown in FIGS. 19A and 19B, when viewed in the Y axis direction, the retractable lens group G3a is disposed at a different position from those of the pitch drive unit 280 and the yaw drive unit 285 in a state of being retracted to outside the optical path. More specifically, when viewed in the Y axis direction, the correction lens group G3b is disposed between the pitch drive unit 280 and the yaw drive unit 285 in the pitch direction (the X axis direction; an example of a third direction perpendicular to the optical axis A). Also, when viewed in the Y axis direction, the retractable lens group G3a is disposed aligned with the correction lens group G3b in the yaw direction (the Z axis direction; and example of a fourth direction perpendicular to the optical axis and the third direction) in a state of being retracted to outside the optical path.

A shutter unit 230 that adjusts the exposure time is disposed inside the base frame body 206. The shutter unit 230 has ND filter vanes (not shown) and shutter vanes (not shown). Since the shutter unit 230 is supported by the base frame 201, it can also be said that the shutter unit 230 is supported by the correction lens support mechanism 290.

Also, a shutter drive mechanism 235 that drives the shutter unit 230 is arranged on the base frame 201. More specifically, the shutter drive mechanism 235 has a first drive unit 231 and a second drive unit 232. The first drive unit 231 drives an ND filter. The second drive unit 232 drives shutter vanes. As shown in FIGS. 19A and 19B, when viewed in the Y axis direction, the correction lens group G3b is disposed between the shutter drive mechanism 235 and the retractable lens group G3a retracted out of the optical path.

The third lens frame 200 has a rotary shaft 224 that protrudes to the Y axis direction positive side of the base frame 201, and a stopper 205 made up of a substantially rectangular projection. The rotary shaft 224 is inserted in a guide hole 253 of the retraction lens frame 250. The stopper 205 is provided for the positioning of the retraction lens frame 250. In a state in which the stopper 205 is in contact with a positioning projection 256 (discussed below) of the retraction lens frame 250, the optical axis C of the retractable lens group G3a substantially coincides with the optical axis A.

3.9.1: Retraction Lens Frame

The retractable lens frame 250 supports the retractable lens group G3a retractably out of the optical path of the optical system O. More specifically, as shown in FIGS. 7, 19A, 19B, 20A, 20B, 21, and 22, the retractable lens frame 250 has a lens frame body 251 that supports the retractable lens group G3a, a linking arm 254 that extends outward from the lens frame body 251, a cylinder 252 arranged at the end of the linking arm 254, a drive projection 255 that extends from the outer peripheral part of the cylinder 252 in the opposite direction from that of the linking arm 254, and a positioning projection 256 that extends from the outer peripheral part of the lens frame body 251 in a direction substantially perpendicular to the linking arm 254.

As shown in FIGS. 19A, 19B, 20A, and 20B, we will now define the insertion position P0, the first retraction position P1 (an example of a first position), and the second retraction position P2 (an example of a second position) as the positions of the retractable lens frame 250. The insertion position P0 is the position of the retractable lens frame 250 at which the optical axis C of the retractable lens group G3a substantially coincides with the optical axis A of the optical system O. The first retraction position P1 is the position of the retractable lens frame 250 when the retractable lens frame 250 is not pushed to the Y axis direction negative side in a state in which the retractable lens group G3a is retracted out of the optical path. The second retraction position P2 is the position of the retractable lens frame 250 when the retractable lens frame 250 is pushed to the Y axis direction negative side in a state in which the retractable lens group G3a is retracted out of the optical path.

The cylinder 252 is linked to the lens frame body 251 by the linking arm 254, and has the guide hole 253. The rotary shaft 224 of the base frame 201 is inserted into the guide hole 253. That is, the retractable lens frame 250 is supported rotatably around the center axis B of the rotary shaft 224 by the base frame 201. It can also be said that the retractable lens frame 250 is rotatably supported by the correction lens support mechanism 290. As shown in FIG. 22, of the rotation directions around the center axis B, one is termed the R3 side and the other the R4 side. The center axis B is set to be parallel to the optical axis A.

Also, as shown in FIG. 22, the cylinder 252 is inserted into the torsion compression coil spring 258. As shown in FIGS. 19A, 19B, and 22, the retractable lens frame 250 is always pushed by the torsion compression coil spring 258 to the R3 side with respect to the base frame 201. Further, the retractable lens frame 250 is always pushed to the Y axis direction positive side with respect to the base frame 201. The positioning projection 256 of the retractable lens frame 250 is pressed against the stopper 205 by the torsion compression coil spring 258. Because of this configuration, the position of the retractable lens frame 250 is kept at the insertion position P0.

The retraction main axis cover 270 is a member that retains the retractable lens frame 250, and is fixed by a screw 271 to the base frame 201. The gap formed between the retraction main axis cover 270 and the base frame body 206 is larger than the size of the cylinder 252 in the Y axis direction. Consequently, the retractable lens frame 250 is movable within a specific range between the retraction main axis cover 270 and the base frame body 206. The movable range of the retractable lens frame 250 in the Y axis direction is set to be the same as the movement amount S1 that the retractable lens frame 250 moves during retraction, or to be greater than the movement amount S1.

Further, the retractable lens frame 250 is pressed against the retraction main axis cover 270 by the torsion compression coil spring 258. More precisely, the cylinder 252 is pressed against the retraction main axis cover 270 by the torsion compression coil spring 258. In this way the retractable lens frame 250 is positioned in the Y axis direction with respect to the base frame 201.

Also, when the retractable lens frame 250 is pushed to the Y axis direction negative side in a state in which the retractable lens group G3a has retracted to the second retraction position P2, the retractable lens frame 250 moves against the pressing force of the torsion compression coil spring 258 to the Y axis direction negative side with respect to the base frame 201. As a result, the retractable lens frame 250 moves in the Y axis direction from the first retraction position P1 to the -housing 2. In the second retraction position P2, the retractable lens group G3a is located on the outer peripheral side of the correction lens group G3b, and the retractable lens group G3a overlaps the correction lens group G3b in the radial direction (or the Z axis direction).

The linking arm 254, the drive projection 255, and the positioning projection 256 are disposed more to the Y axis direction positive side than the end of the lens frame body 251 on the Y axis direction negative side. That is, the lens frame body 251 protrudes more to the Y axis direction positive side than the linking arm 254, the drive projection 255, and the positioning projection 256. Therefore, even when the retractable lens frame 250 moves from the first retraction position P1 to the second retraction position P2 on the Y axis direction negative side, the linking arm 254 does not interfere with the correction lens frame 240.

Also, an aperture cap 260 is fixed along with the retractable lens group G3a to the lens frame body 251 of the retractable lens frame 250. More precisely, the aperture cap 260 is attached on the Y axis direction positive side of the lens frame body 251, and is disposed on the Y axis direction positive side (the front side) of the retractable lens group G3a. That is, the retractable lens group G3a is disposed adjacent to the aperture cap 260. The aperture cap 260 has the function of a fixed aperture that restricts the optical path diameter incident on the retractable lens group G3a. Therefore, the aperture value of the optical system O is determined by the aperture cap 260. At the insertion position P0 shown in FIG. 19B, the retractable lens group G3a is disposed between the aperture cap 260 and the correction lens group G3b.

In the retracted state the retractable lens frame 250 is driven by a drive retracting mechanism 295 so that the retractable lens group G3a retracts to the first retraction position P1. Further, the retractable lens frame 250 is also driven in the Y axis direction by the drive retracting mechanism 295 so that the retractable lens group G3a retracts to the second retraction position P2.

The drive retracting mechanism 295 is mainly constituted by the rectilinear frame 80 and the torsion compression coil spring 258. More specifically, as shown in FIGS. 17 and 21, the inclined face 86a, the rectilinear restriction face 86b, and the end face 86c are formed on the inner peripheral part of the rectilinear frame 80. The inclined face 86a, the rectilinear restriction face 86b, and the end face 86c are faces that serve to guide the retractable lens frame 250 from the insertion position P0 to the second retraction position P2, and are formed continuously. The drive projection 255 of the retractable lens frame 250 is arranged slidably with the inclined face 86a, the rectilinear restriction face 86b, and the end face 86c.

The inclined face 86a is provided to rotate the retractable lens frame 250 from the insertion position P0 to the first retraction position P1, or from the first retraction position P1 to the insertion position P0, and is inclined with respect to the Y axis direction and the circumferential direction. The inclined face 86a substantially faces the Y axis direction and the circumferential direction. The rectilinear restriction face 86b is provided to keep the rotational position of the retractable lens frame 250 at the first retraction position P1 or the second retraction position P2, and extends in the Y axis direction. The rectilinear restriction face 86b substantially faces the circumferential direction. The end face 86c is provided to move the retractable lens frame 250 from the first retraction position P1 to the second retraction position P2 in the Y axis direction, and extends in the circumferential direction. The end face 86c substantially faces the Y axis direction. The end face 86c keeps the position of the retractable lens frame 250 in the Y axis direction at the second retraction position P2.

In the imaging state (wide angle end) shown in FIG. 9, the retractable lens frame 250 is disposed at the insertion position P0 (the position shown in FIG. 9B), and the rectilinear frame 80 and the retractable lens frame 250 are separated in the Y axis direction. When the rectilinear frame 80 moves from this state to the Y axis direction negative side with respect to the retractable lens frame 250, the inclined face 86a of the rectilinear frame 80 comes into contact with the drive projection 255, and the inclined face 86a guides the drive projection 255 to the R4 side. As a result, the retractable lens frame 250 rotates around the center axis B to the R4 side. When the drive projection 255 moves to the portion of contact between the inclined face 86a and the rectilinear restriction face 86b, the retractable lens frame 250 reaches the first retraction position P1 (the position shown in FIG. 19A).

After the retractable lens frame 250 has been driven to the first retraction position P1, the rectilinear frame 80 moves further to the Y axis direction negative side while the rotational position of the retractable lens frame 250 is kept at the first retraction position P1 by the rectilinear restriction face 86b. When the drive projection 255 hits the end face 86c, the retractable lens frame 250 this time is pushed in the Y axis direction by the rectilinear frame 80, and the retractable lens frame 250 moves to the Y axis direction negative side along with the rectilinear frame 80 against the pressing force of the torsion compression coil spring 258.

When the rectilinear frame 80 stops at the retracted position, the retractable lens frame 250 stops at the second retraction position P2. As shown in FIG. 20A, the retractable lens frame 250 moves by the movement amount S1 in the Y axis direction. In the state shown in FIG. 20A, the drive projection 255 is pressed against the end face 86c by the pressing force of the torsion compression coil spring 258, and the drive projection 255 is pressed against the rectilinear restriction face 86b by the pressing force of the torsion compression coil spring 258. Accordingly, the position of the retractable lens frame 250 in the retracted state is maintained at the second retraction position P2 shown in FIGS. 19A and 20A.

Also, as shown in FIG. 20A, at the first retraction position P1 the lens frame body 251 of the retractable lens frame 250 (or the retractable lens group G3a) is disposed at a different position from that of the correction lens frame 240 (a position that does not overlap in the Y axis direction). More precisely, at the first retraction position P1, the lens frame body 251 of the retractable lens frame 250 is disposed at a different position from that of the maximum movable range of the correction lens frame 240 (a position that does not overlap in the Y axis direction). Therefore, the lens frame body 251 does not interfere with the correction lens frame 240 even if the retractable lens frame 250 moves in the Y axis direction in a state in which the retractable lens frame 250 is disposed at the first retraction position P1.

Furthermore, at the second retraction position P2, part of the retractable lens frame 250 (or part of the retractable lens group G3a) has entered to the side of the correction lens group G3b and the correction lens frame 240. To put this another way, part of the retractable lens frame 250 (more precisely, part of the lens frame body 251) or part of the retractable lens group G3a overlaps the correction lens frame 240 in the Z axis direction. The phrase “part of the retractable lens frame 250 and the retractable lens frame 250 overlaps in the Z axis direction” here means that the projected images overlap in the Z axis direction, for example. Retracting the retractable lens frame 250 to the second retraction position P2 allows the space around the correction lens frame 240 to be utilized more effectively.

As discussed above, at the first retraction position P1, the lens frame body 251 of the retractable lens frame 250 is disposed at a different position from that of the maximum movable range of the correction lens frame 240 (a position that does not overlap in the Y axis direction). Therefore, even in a state in which the correction lens frame 240 can freely move around, the retractable lens frame 250 disposed at the second retraction position P2 will not interfere with the correction lens frame 240.

The features of the third lens frame 200 will now be described further. More specifically, as shown in FIGS. 8, 20A, and 20B, the base frame 201 supports the retractable lens frame 250, the correction lens frame 240, and the shutter unit 230. In zooming operation during imaging with the digital camera 1, the retractable lens frame 250, the correction lens support mechanism 290 (the base frame 201 and the correction lens frame 240), and the shutter unit 230 move integrally in the Y axis direction. This allows members to be shared, and is therefore advantageous in terms of reducing the size.

Also, as shown in FIG. 20A, the center thickness T1 of the retractable lens group G3a is greater than the center thickness T2 of the correction lens group G3b. In this embodiment, the thickness T1 of the retractable lens group G3a is approximately 5.3 mm, whereas the thickness T2 of the correction lens group G3b is approximately 1 mm, which means that a considerable difference in thickness is set.

The thickness of the lens barrel 3 is determined more or less by the thickness of the lens barrier 50, the thickness of the first lens group G1, the thickness of the second lens group G2, the thickness of the third lens group G3, the thickness of the fourth lens group G4, and the thickness of the CCD image sensor 141. Therefore, the thickness of the lens barrel 3 in its retracted state can be reduced by an amount equal to the thickness T1 of the retractable lens group G3a by retracting the retractable lens group G3a to a position away from the optical axis A in a retracted state. The lens barrel thickness H (see FIG. 8) can be reduced by decreasing the thickness T2 of the correction lens group G3b and increasing the thickness T1 of the retractable lens group G3a.

Furthermore, as shown in FIG. 8, the lens barrel diameter D is determined more or less by the second lens frame 190 and the surrounding frames (in this embodiment, this refers to the retractable lens frame 250, the first lens frame 60, the rotary cam frame 70, the drive frame 30, the camera cam frame 40, and the fixed frame 20). The lens barrel diameter D of the surrounding frames is determined to resist impact in the event that the digital camera 1 is dropped, so to reduce the lens barrel diameter D, it is necessary to reduce the second lens frame 190 and the retractable lens frame 250. Specifically, the diameter of the second lens group G2 and the retractable lens group G3a must be reduced. Since the aperture position has the smallest effective optical path diameter in the optical system O, the diameter of the lenses near the aperture is smaller. In this embodiment, the aperture cap 260 is assigned the role of a fixed stop, and can reduce the lens diameter of the second lens group G2 and the retractable lens group G3a. Another factor that determines the lens barrel diameter D is the surrounding frames and the diameter of the substantially cylindrical base frame 201. To reduce the size of the base frame 201, it is effective to reduce the diameter of the correction lens group G3b. The diameter of the retractable lens group G3a can be reduced by disposing the retractable lens group G3a near the aperture cap 260 having the aperture function (more precisely, immediately after the aperture cap 260). This affords a reduction in the diameter of the base frame 201.

The above constitution allows the lens barrel thickness H and the lens barrel diameter D to be reduced.

3.9.2: Shutter Unit

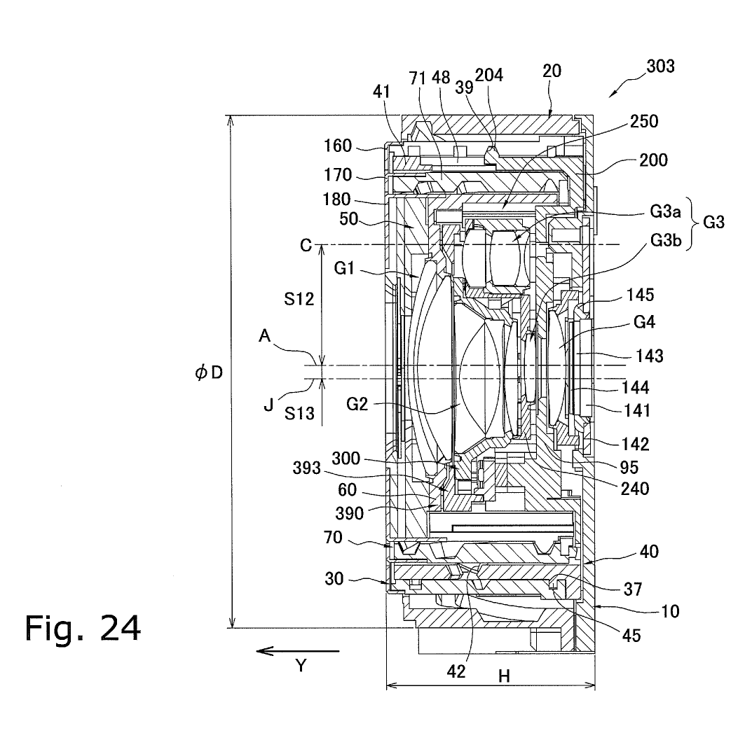

The shutter unit 230 is a device for adjusting the exposure time of the image sensor to light, and as shown in FIGS. 23A and 23B, it is disposed between the correction lens group G3b and the fourth lens group G4. More specifically, the shutter unit 230 is arranged within the base frame 201, and is disposed between the correction lens frame 240 and the base frame 201. The shutter unit 230 is movable along with the third lens frame 200 in the Y axis direction with respect to the fixed frame 20. The shutter unit 230 has two shutter vanes (not shown), a light-reducing ND (neutral density) filter made up of a thin film, and a shutter drive mechanism 235. The shutter vanes are thin blades composed of PET (polyethylene terephthalate) that blocks out light. The ND filter has substantially uniform density characteristics at various wavelengths. The shutter drive mechanism 235 has a first drive unit 231 that drives the ND filter, and a second drive unit 232 that drives the shutter vanes. An opening 233 is opened and closed by the ND filter when the first drive unit 231 drives the ND filter. The opening 233 is opened and closed by the shutter vanes when the second drive unit 232 drives the shutter vanes.

3.10: Fourth Lens Frame

As shown in FIG. 7, the fourth lens frame 90 is a member for supporting the fourth lens group G4 movably in the Y axis direction, and is supported movably in the Y axis direction by two shafts 11a and lib formed on the master flange 10. The drive of the fourth lens frame 90 is performed by a focus motor 120 fixed to the master flange 10. When the fourth lens frame 90 is driven by the focus motor 120, the fourth lens frame 90 moves in the Y axis direction with respect to the master flange 10. This allows the focus to be adjusted in the optical system O.

3.11: Imaging Element Unit

As shown in FIG. 7, an imaging element unit 140 has an IR absorbing glass 144, a CCD image sensor 141, a rubber dust bather 145, a CCD plate 142, and a CCD cover glass 143.

The master flange 10 is fixed to the fixed frame 20, and is disposed on the Y axis direction negative side of the fixed frame 20. A rectangular opening 12 is foamed in the master flange 10. The optical image formed by the optical system O passes through the opening 12 and is imaged on the light receiving face of the CCD image sensor 141.

The IR absorbing glass 144 is a flat, rectangular member that is smaller than the opening 12, and is disposed within the opening 12. The IR absorbing glass 144 subjects light passing through the opening 12 to infrared absorption processing (an example of optical processing). The CCD image sensor 141 converts the light transmitted by the IR absorbing glass 144 into an electrical signal.

### 4: Operation of Digital Camera

The operation of the digital camera 1 will be described through reference to FIGS. 1 to 3.

4.1: When Power is Off When the power switch 6 is in its off position, the lens barrel 3 is stopped in its retracted state (the state shown in FIG. 8, in which the length of the lens barrel 3 in the Y axis direction is shortest), so that the lens barrel 3 will fit within the external dimensions of the housing 2 in the Y axis direction.

In this state, the lens barrier 50 of the lens barrel 3 is closed. More specifically, the shutting lever 53 of the lens barrier 50 is pushed to the rotational direction R2 side by the inclined projection 89 of the rectilinear frame 80. Accordingly, the barrier vanes 51 of the lens barrier 50 are kept closed.

Meanwhile, the rectilinear restriction face 86b of the rectilinear frame 80 pushes the drive projection 255 of the retractable lens frame 250 to the R4 side around the center axis B of the rotary shaft 224. Accordingly, the retractable lens group G3a is stopped at the retracted position at which the optical axis C is away from the optical axis A by the retraction amount S2 (see FIGS. 19A and 20A). Also, the end face 86c of the rectilinear frame 80 holds the drive projection 255 of the retractable lens frame 250 to the Y axis direction negative side. Consequently, the distance between the retractable lens frame 250 and the shutter unit 230 is shorter (see FIG. 20A) by the movement amount S1 compared to the imaging state (see FIG. 9).

4.2: Operation When Power is On

When the power switch 6 is switched on, power is supplied to the various components and the lens barrel 3 is driven from its retracted state to its imaging state. More specifically, the drive frame 30 is driven by the zoom motor unit 110 to the R2 side by a specific angle with respect to the fixed frame 20. As a result, the drive frame 30 moves along the cam grooves 23 to the Y axis direction positive side with respect to the fixed frame 20 while rotating with respect to the fixed frame 20.

When the drive frame 30 moves in the Y axis direction while rotating with respect to the fixed frame 20, the first rotary projections 43 and the second rotary projections 45 cause the camera cam frame 40 to move integrally with the drive frame 30 in the Y axis direction. At this point, since the rectilinear projections 47a to 47c of the camera cam frame 40 are guided in the Y axis direction by the rectilinear grooves 27a to 27c of the fixed frame 20, the camera cam frame 40 moves integrally with the drive frame 30 in the Y axis direction without rotating with respect to the fixed frame 20 (see FIGS. 12A and 12B).

Also, as shown in FIG. 14, the distal ends 76b of the cam followers 76 of the rotary cam frame 70 are fitted into the rectilinear grooves 38 of the drive frame 30, so the rotary cam frame 70 rotates along with the drive frame 30 with respect to the fixed frame 20. As a result, the rotary cam frame 70 and the camera cam frame 40 rotate relatively. Sine the cam followers 76 of the rotary cam frame 70 go through the cam through-grooves 42 of the camera cam frame 40, when the rotary cam frame 70 rotates with respect to the camera cam frame 40, the rotary cam frame 70 moves in the Y axis direction while rotating with respect to the camera cam frame 40 and the fixed frame 20, according to the shape of the cam through-grooves 42.

The rectilinear frame 80 is arranged to be rotatable with respect to the rotary cam frame 70 and movable integrally in the Y axis direction, and the rectilinear frame 80 is arranged to be movable in the Y axis direction without rotating with respect to the camera cam frame 40. More specifically, the rotary projections 83 of the rectilinear frame 80 are inserted into the rotary grooves 77 of the rotary cam frame 70, and the second rectilinear projections 85 of the rectilinear frame 80 are inserted into the rectilinear grooves 46 of the camera cam frame 40. With this constitution, when the rotary cam frame 70 moves in the Y axis direction while rotating with respect to the fixed frame 20, the rectilinear frame 80 moves in the Y axis direction integrally with the rotary cam frame 70 without rotating with respect to the fixed frame 20 and the camera cam frame 40.

Furthermore, when the rotary cam frame 70 rotates with respect to the fixed frame 20, the first cam followers 68 of the first lens frame 60 are guided in the Y axis direction by the first cam grooves 72 of the rotary cam frame 70. Accordingly, the first lens frame 60 moves in the Y axis direction with respect to the rotary cam frame 70 and the rectilinear frame 80. At this point, since the first rectilinear grooves 63 of the first lens frame 60 are inserted into the first rectilinear projections 82 of the rectilinear frame 80, the first lens frame 60 moves in the Y axis direction without rotating with respect to the rectilinear frame 80. Therefore, the first lens frame 60 moves in the Y axis direction without rotating with respect to the fixed frame 20 (while rotating with respect to the rotary cam frame 70), according to the shape of the first cam grooves 72. At this point, since a gap is ensured between the second cam followers 69 and the second cam grooves 73, the second cam followers 69 move through the second cam grooves 73 without touching the second cam grooves 73.

The cam followers 192 of the second lens frame 190 are fitted into the third cam grooves 74 of the rotary cam frame 70. Since the rectilinear projections 191 of the second lens frame 190 are inserted into the second rectilinear grooves 64 of the first lens frame 60, the second lens frame 190 moves in the Y axis direction without rotating with respect to the first lens frame 60. With this constitution, the second lens frame 190 moves in the Y axis direction according to the shape of the third cam grooves 74, without rotating with respect to the camera cam frame 40 or the fixed frame 20.

Also, since the rectilinear projections 203 of the third lens frame 200 are inserted into the rectilinear through-grooves 48 of the camera cam frame 40, the third lens frame 200 is movable in the Y axis direction without rotating with respect to the fixed frame 20 and the camera cam frame 40. Furthermore, the cam followers 204 are fitted into the cam grooves 39 of the drive frame 30. With this constitution, the third lens frame 200 moves in the Y axis direction according to the shape of the cam grooves 39, without rotating with respect to the camera cam frame 40 or the fixed frame 20. As shown in FIGS. 8 and 9, when drive is performed by the zoom motor unit from the retracted state to the imaging state, the drive frame 30 moves to the Y axis direction positive side while rotating with respect to the fixed frame 20, but the third lens frame 200 moves to the Y axis direction negative side with respect to the drive frame 30. Accordingly, the third lens frame 200 moves to the Y axis direction positive side with respect to the fixed frame 20, but the movement amount of the third lens frame 200 with respect to the third lens frame 200 is limited.

Meanwhile, since the second rectilinear projections 85 of the rectilinear frame 80 are inserted into the rectilinear grooves 46 of the camera cam frame 40, the rectilinear frame 80 is movable in the Y axis direction without rotating with respect to the fixed frame 20 and the camera cam frame 40. Furthermore, since the rotary projections 83 of the rectilinear frame 80 are meshed with the rotary projections 75 of the rotary cam frame 70, the rectilinear frame 80 moves in the Y axis direction along with the rotary cam frame 70 in a state in which relative rotation is permitted. When the drive frame 30 rotates with respect to the fixed frame 20, the rotary cam frame 70 rotates with respect to the camera cam frame 40, and the cam followers 76 of the rotary cam frame 70 are guided by the cam through-grooves 42 of the camera cam frame 40. Consequently, the rectilinear frame 80 moves in the Y axis direction along with the rotary cam frame 70 without rotating with respect to the fixed frame 20 and the camera cam frame 40. More specifically, the rectilinear frame 80 moves to the Y axis direction positive side along with the rotary cam frame 70 without rotating with respect to the fixed frame 20. The movement amount of the rectilinear frame 80 with respect to the fixed frame 20 here is greater than the movement amount of the third lens frame 200 with respect to the fixed frame 20, so in the course of switching the lens barrel 3 from its retracted state to the imaging state, the rectilinear frame 80 moves away from the third lens frame 200 to the Y axis direction positive side.

As the rectilinear frame 80 thus moves away from the third lens frame 200, the retractable lens frame 250 moves to the Y axis direction positive side along with the rectilinear frame 80 in a state in which the drive projection 255 is pressed against the end face 86c of the rectilinear frame 80. At this point the retractable lens frame 250 moves to the Y axis direction positive side with respect to the base frame 201. When the retractable lens frame 250 hits the retraction main axis cover 270, movement of the retractable lens frame 250 in the Y axis direction with respect to the base frame 201 stops, and the rectilinear frame 80 moves away from the retractable lens frame 250 to the Y axis direction positive side.

As the rectilinear frame 80 moves away from the retractable lens frame 250 to the Y axis direction positive side, the drive projection 255 of the retractable lens frame 250 moves to the inclined face 86a while sliding with the rectilinear restriction face 86b of the rectilinear frame 80, and further slides with the inclined face 86a. At this point, since the drive projection 255 is pressed against the inclined face 86a by the torsion force of the torsion compression coil spring 258, the retractable lens frame 250 rotates from the first retraction position P1 to the insertion position P0 on the R3 side, according to the shape of the inclined face 86a. The retractable lens frame 250 is positioned at the position where the positioning projection 256 hits the stopper 205 (that is, the insertion position P0) by the torsion force of the torsion compression coil spring 258 (see FIGS. 19B and 20B). In the insertion position P0, the optical axis C of the retractable lens group G3a substantially coincides with the optical axis A of the optical system O. Here, a state in which “the optical axis C of the retractable lens group G3a substantially coincides with the optical axis A of the optical system O” includes not only a state in which the optical axis C coincides completely with the optical axis A, but also a state in which the optical axis C is offset from the optical axis A.

As discussed above, when drive force is inputted to the drive frame 30 during retraction operation, the drive frame 30 moves in the Y axis direction with respect to the fixed frame 20, and this is accompanied by movement of the various components supported by the drive frame 30 in the Y axis direction with respect to the fixed frame 20. When the drive frame 30 rotates by a specific angle, rotation of the drive frame 30 stops, and the first lens frame 60, the second lens frame 190, and the third lens frame 200 stop at the wide angle end. The above operation results in the lens barrel 3 entering an imaging state (such as the state shown in FIG. 9), and makes possible imaging with the digital camera 1.

4.3: Zoom Operation During Imaging

4.3.1: Operation on Telephoto Side

When the zoom adjusting lever 7 is moved to the telephoto side, the zoom motor unit 110 drives the drive frame 30 in the R2 side with respect to the fixed frame 20 according to the rotational angle and operation duration of the zoom adjusting lever 7. As a result, the rotary cam frame 70 moves to the Y axis direction positive side with respect to the drive frame 30 while rotating along with the drive frame 30. At this point, the drive frame 30 moves slightly in the Y axis direction along the cam grooves 23 while rotating with respect to the fixed frame 20.

Also, the first lens frame 60 mainly moves to the Y axis direction positive side without rotating with respect to the fixed frame 20. Meanwhile, the second lens frame 190 mainly moves to the Y axis direction negative side without rotating with respect to the fixed frame 20. Furthermore, the third lens frame 200 mainly moves to the Y axis direction positive side without rotating with respect to the fixed frame 20. At this point, the retractable lens frame 250, the correction lens support mechanism 290, and the shutter unit 230 move integrally to the Y axis direction positive side. As a result of these operations, the zoom ratio of the optical system O gradually increases. When the lens barrel 3 reaches the telephoto end, the lens barrel 3 stops in the state shown in FIG. 10.

In the above operation, since a state is maintained in which the inclined face 86a of the rectilinear frame 80 is separated from the drive projection 255, the retractable lens frame 250 is in a state of being stopped at the insertion position P0.

4.3.2: Operation on Wide Angle Side

When the zoom adjusting lever 7 is moved to the wide angle side, the drive frame 30 is driven by the zoom motor unit 110 to the R1 side with respect to the fixed frame 20 according to the rotational angle and operation duration of the zoom adjusting lever 7. As a result, the rotary cam frame 70 moves to the Y axis direction negative side with respect to the drive frame 30 while rotating along with the drive frame 30. The drive frame 30 here moves slightly in the Y axis direction along the cam grooves 23 while rotating with respect to the fixed frame 20.

Also, the first lens frame 60 moves mainly to the Y axis direction negative side without rotating with respect to the rotary cam frame fixed frame 20. Meanwhile, the second lens frame 190 moves mainly to the Y axis direction positive side without rotating with respect to the fixed frame 20. Furthermore, the third lens frame 200 moves mainly to the Y axis direction negative side without rotating with respect to the fixed frame 20. At this point the retractable lens frame 250, the correction lens support mechanism 290, and the shutter unit 230 move integrally to the Y axis direction negative side. As a result of these operations, the zoom ratio of the optical system O gradually decreases. When the lens barrel 3 reaches the wide angle end, the lens barrel 3 stops in the state shown in FIG. 9.

Just as with operation on the telephoto side, in the above operation, since a state is maintained in which the inclined face 86a of the rectilinear frame 80 is separated from the drive projection 255, the retractable lens frame 250 is in a state of being stopped at the insertion position P0.

4.4: When Power is Off

When the power switch 6 is in its off position, the lens barrel 3 is driven from an imaging state to a retracted state. More specifically, the drive frame 30 is driven by the zoom motor unit 110 by a specific angle to the R1 side with respect to the fixed frame 20. As a result, the lens barrel 3 operates in the reverse order from that in the operation when the power is on as discussed above.

For example, during retraction operation, since the rectilinear frame 80 and the third lens frame 200 move closer to each other, the drive projection 255 of the retractable lens frame 250 is guided by the inclined face 86a of the rectilinear frame 80. More specifically, the retractable lens frame 250 is rotationally driven by the inclined face 86a to the R4 side (see FIG. 19A). When the retractable lens frame 250 reaches the first retraction position P1, the drive projection 255 reaches the end face 86c while sliding with the rectilinear restriction face 86b, and the drive projection 255 is pushed by the end face 86c to the Y axis direction negative side. As a result, the drive projection 255 is driven by the rectilinear frame 80 to the Y axis direction negative side with respect to the base frame 201, and the retractable lens frame 250 reaches the second retraction position P2.

Meanwhile, since the second lens frame 190 and the third lens frame 200 gradually move closer to each other in the Y axis direction, in a state in which the retractable lens frame 250 is disposed at the second retraction position P2, the second lens group G2 moves closer to the correction lens group G3b in the Y axis direction. In a state in which the second lens group G2 has moved closer to the correction lens group G3b, relative movement between the second lens frame 190 and the third lens frame 200 in the Y axis direction comes to a stop.

As a result of this operation, the lens barrel 3 is in the retracted state shown in FIG. 8.

When the lens barrel 3 is in its retracted state, at least part of the retractable lens frame 250 can be disposed within the movable range MA of the correction lens frame 240 (see FIGS. 19A and 20A). In this case, before the retractable lens frame 250 reaches the second retraction position P2, the correction lens frame 240 is driven by the first drive unit 231 and the second drive unit 232 to the Z axis direction negative side to a position where the correction lens frame 240 does not interfere with the retractable lens frame 250. This allows the retraction amount S2 to be reduced, and is also advantageous in terms of reducing the size of the lens barrel 3 in the radial direction.

### 5: Features

The features of the lens barrel 3 described above are compiled below.

5.1 With this lens barrel 3, since the correction lens support mechanism 290 is driven by the drive correcting mechanism 289 so that the correction lens group G3b moves in a direction perpendicular to the optical axis A, blur correction can be performed. In particular, when blur correction is performed by moving a correction lens group, the drive correcting mechanism 289 can be smaller than when blur correction is performed by moving an imaging element, so a reduction in the size of the lens barrel 3 is easy to achieve.

Also, the retractable lens group G3a is supported by the retractable lens frame 250 retractably out of the optical path, and the retractable lens frame 250 is driven by the drive retracting mechanism 295 so that the retractable lens frame 250 retracts out of the optical path. Accordingly, the size of the lens barrel 3 in is retracted state can be shortened by an amount equal to the retractable lens group G3a.

Thus, a further reduction is size is possible with this lens barrel 3.

5.2 As shown in FIGS. 20A and 20B, since the center thickness T1 of the retractable lens group G3a is greater than the center thickness T2 of the correction lens group G3b, the size reduction effect can be further enhanced.

5.3 As shown in FIG. 22, since the retractable lens frame 250 is supported by the correction lens support mechanism 290 (more precisely, the base frame 201), the members constituting the correction lens support mechanism 290 can also be the members that support the retractable lens frame 250. This cuts down on the number of parts required, and further reduces the size of the lens barrel 3.

Sharing members also improves positioning accuracy of the retractable lens group G3a with respect to the correction lens group G3b.

Furthermore, since the shutter unit 230 is supported by the correction lens support mechanism 290, the members supporting the shutter unit 230 can also be the members that constitute the correction lens support mechanism 290. This cuts down on the number of parts required, and further reduces the size of the lens barrel 3.

5.4 As shown in FIG. 23A, since the correction lens group G3b is disposed between the shutter unit 230 and the retractable lens group G3a in an imaging state, the retractable lens group G3a can be disposed away from the shutter unit 230. Consequently, even if the retractable lens group G3a is driven in the Y axis direction, for example, there is no need for a cut-out to be arranged in the shutter unit 230. Therefore, a drop in the performance of the lens barrel 3 due to the entrance of unnecessary light rays can be prevented.

5.5 As shown in FIGS. 20A and 23B, the retractable lens frame 250 is driven by the drive retracting mechanism 295 so that the retractable lens group G3a retracts to the outer peripheral side of the correction lens group G3b. Accordingly, in a retracted state the retractable lens group G3a and the correction lens group G3b can be disposed more efficiently, and the lens barrel 3 can be further reduced in size.

5.6 As shown in FIGS. 20A and 23A, in a state in which the retractable lens frame 250 is disposed at the insertion position P0, the retractable lens group G3a is disposed between the aperture cap 260 and the correction lens group G3b. Since the retractable lens group G3a is thus disposed adjacent to the aperture cap 260, the diameter of the retractable lens group G3a can be reduced. This makes it possible to reduce the space required to retract the retractable lens group G3a, keeps the diameter D of the lens barrel 3 from becoming larger, and allows the lens barrel thickness H to be reduced.

5.7 As shown in FIGS. 20A and 23B, since the aperture cap 260 is fixed to the retractable lens frame 250 along with the retractable lens group G3a, a configuration is possible in which the retractable lens group G3a and the aperture cap 260 are retracted out of the optical path. Consequently, the lens barrel 3 can be made even smaller, by an amount equal to the thickness of the aperture cap 260.

5.8 As shown in FIG. 19A, when viewed in the Y axis direction, in a state in which the retractable lens frame 250 is disposed in the retracted state, the retractable lens group G3a is disposed at a different position from that of the pitch drive unit 280 and the yaw drive unit 285. That is, the retractable lens group G3a does not overlap the pitch drive unit 280 and the yaw drive unit 285 in the Y axis direction.

More precisely, when viewed in the Y axis direction, the correction lens group G3b is disposed between the pitch drive unit 280 and the yaw drive unit 285 in the pitch direction (X axis direction). Furthermore, in a state in which the retractable lens frame 250 is disposed at the retracted position, the retractable lens group G3a is disposed aligned with the correction lens group G3b in the yaw direction (Z axis direction). Accordingly, the retractable lens group G3a, the pitch drive unit 280, and the yaw drive unit 285 can be disposed efficiently around the correction lens group G3b.

Further, as shown in FIG. 19A, when viewed in the Y axis direction, in a state in which the retractable lens frame 250 is disposed at the retracted position, the correction lens group G3b is disposed between the retractable lens group G3a and the shutter drive mechanism 235. Accordingly, the retractable lens group G3a, the pitch drive unit 280, the yaw drive unit 285, and the shutter drive mechanism 235 can be disposed efficiently around the correction lens group G3b.

Disposing the components as above allows the lens barrel thickness H to be reduced and the lens barrel diameter D to be smaller.

### Second Embodiment

In the first embodiment above, the retractable lens frame 250 is retracted to avoid the second lens frame 190, but when the diameter of the second lens group G2 is large, the retractable lens frame 250 protrudes far outward in the radial direction, and this can make it harder to reduce the size of the lens barrel 3 in the radial direction.

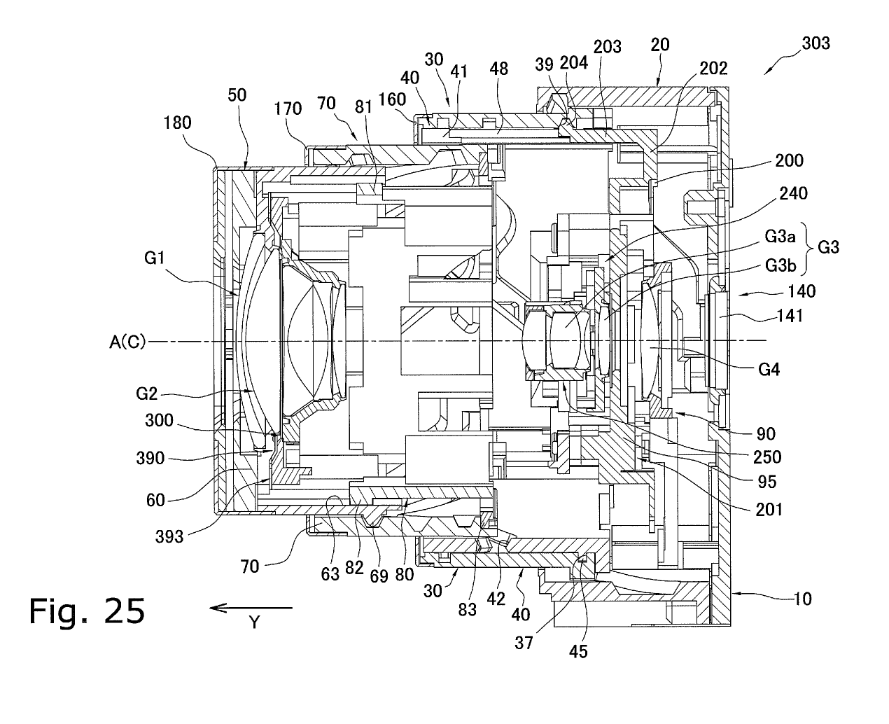

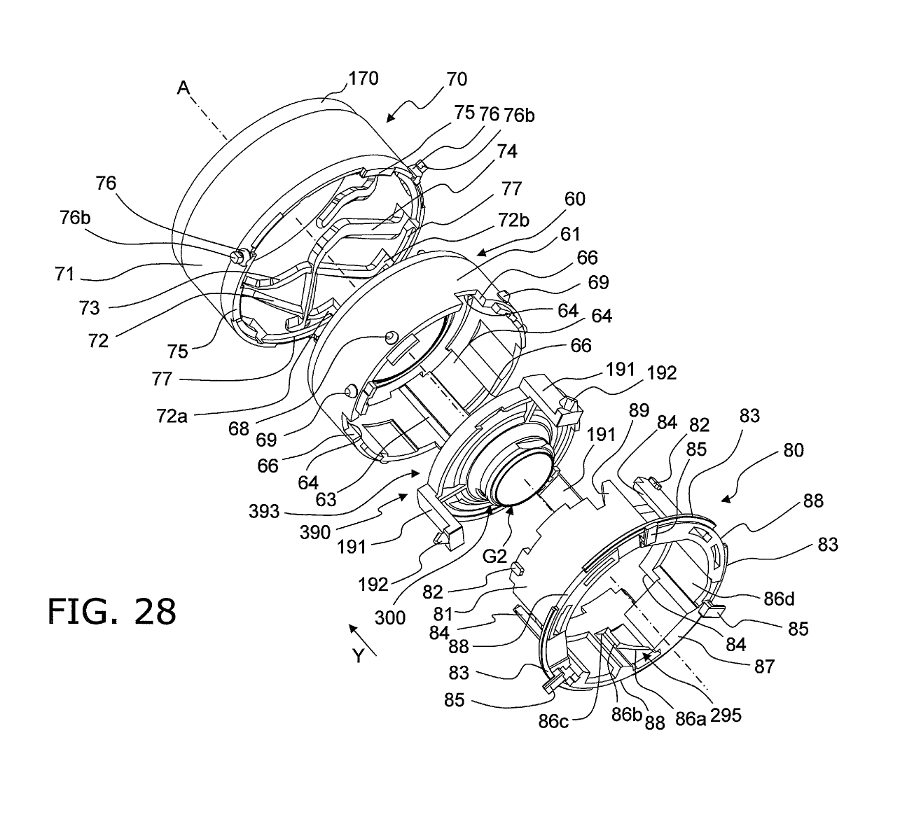

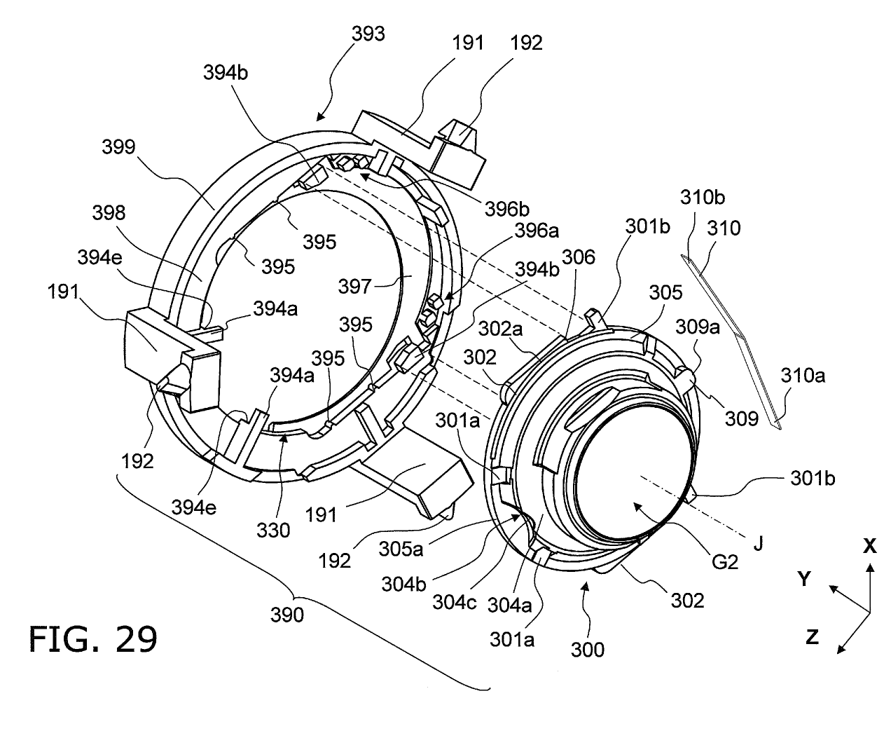

In view of this, a constitution is possible in which the second lens group G2 is retracted in addition to the retractable lens group G3a. A lens barrel 303 pertaining to the second embodiment will now be described through reference to FIGS. 24 to 33B.

Those components having substantially the same function as the components in the first embodiment above will be numbered the same, and will not be described in detail again.

### 1: Configuration of Lens Barrel

As shown in FIGS. 24 to 28, the lens barrel 303 comprises the optical system O, the fixed frame 20, the zoom motor unit 110, the master flange 10, the drive frame 30, the camera cam frame 40, the rotary cam frame 70, and the rectilinear frame 80.

The lens barrel 303 further comprises the first lens frame 60 that supports the first lens group G1, a second lens frame 390 that supports the second lens group G2, the retractable lens frame 250 that supports the retractable lens group G3a, the correction lens frame 210 that supports the image blur correction lens group G3b, the third lens frame 200 that supports the retractable lens frame 250 and the correction lens frame 210, and the fourth lens frame 90 that supports the fourth lens group G4. Compared to the lens barrel 3 discussed above, the difference with this lens barrel 303 lies in the configuration of the second lens frame 390.

More specifically, the second lens frame 390 is similar to the above-mentioned second lens frame 190 in that it is disposed movably in the Y axis direction without rotating with respect to the fixed frame 20. Since the third lens frame 200 including the retractable lens frame 250 is also disposed movably in the Y axis direction with respect to the fixed frame 20, the second lens frame 390 can be said to be disposed movably along the optical axis A of the optical system O with respect to the retractable lens frame 250.

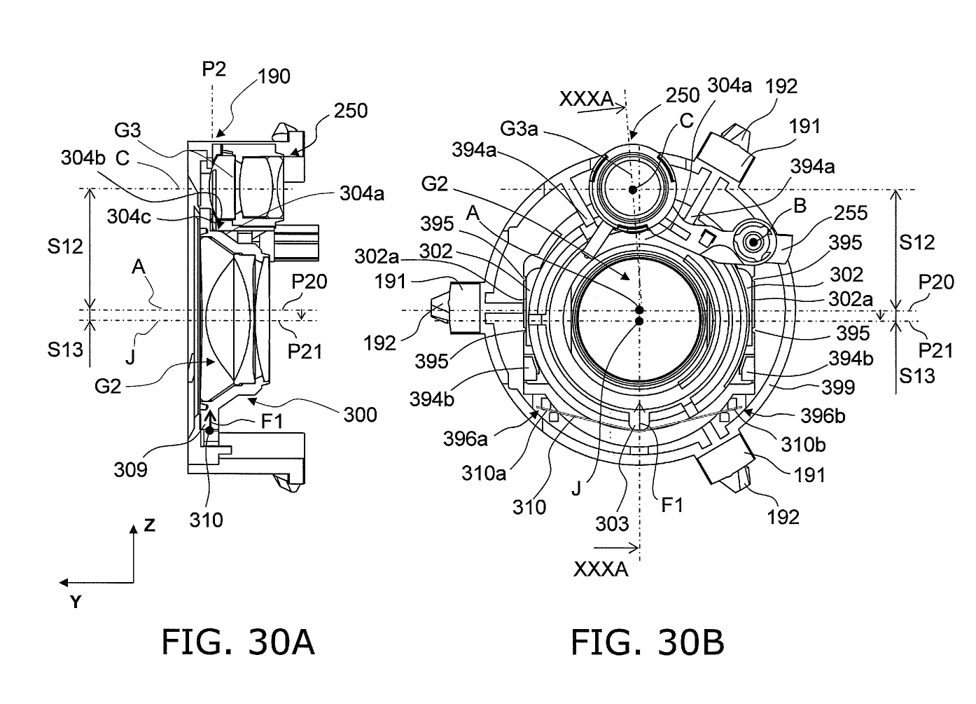

As shown in FIG. 29, the second lens frame 390 (an example of a lens support frame) has a second lens frame body 393 (an example of a lens support frame body), a second retractable lens frame 300 (one example of a shift frame), and a leaf spring 310 (one example of a holding member). The second lens frame body 393 and the second retractable lens frame 300 are each a single member formed from integrally from a resin, for example. The second lens group G2 is attached to the second retractable lens frame 300. The second retractable lens frame 300 is supported by the second lens frame body 393 movably in a direction perpendicular to the optical axis J of the second lens group G2. The leaf spring 310 supports the second retractable lens frame 300 at a specific position with respect to the second lens frame body 393.

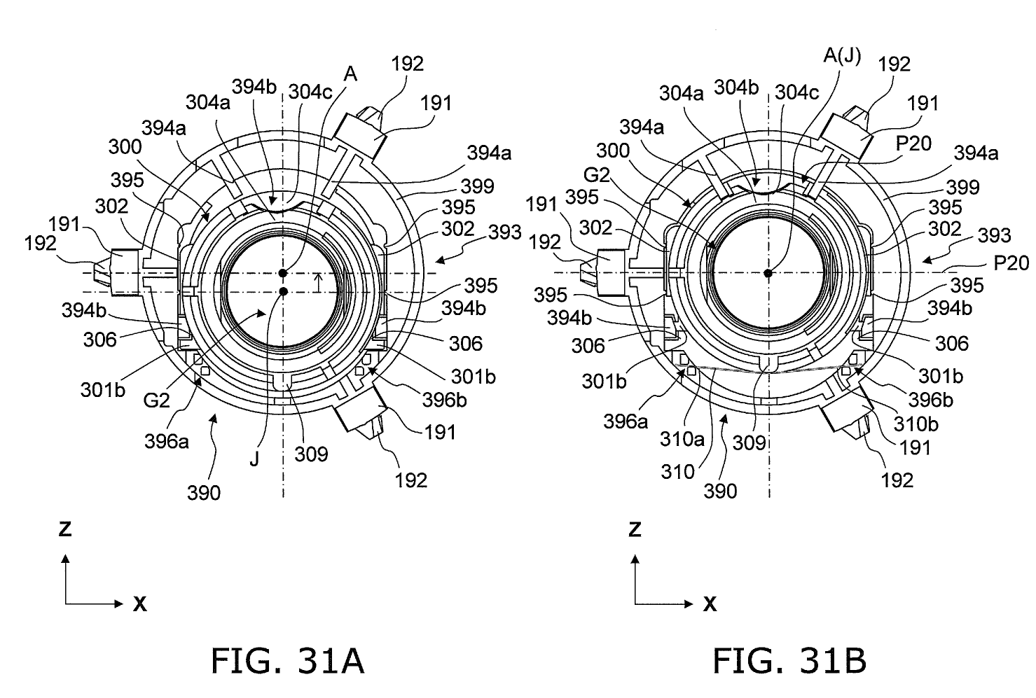

As shown in FIG. 29, the second lens frame body 393 is disposed movably in the optical axis A of the optical system O with respect to the retractable lens frame 250, and is supported by the rectilinear frame 80 movably in the Y axis direction. The second lens frame body 393 supports the second retractable lens frame 300 movably in a direction (the Z axis direction in this embodiment) perpendicular to the optical axis J of the second lens group G2. More specifically, as shown in FIGS. 30A and 30B, the second lens frame body 393 supports the second retractable lens frame 300 movably at least from a reference position P20 to an offset position P21.

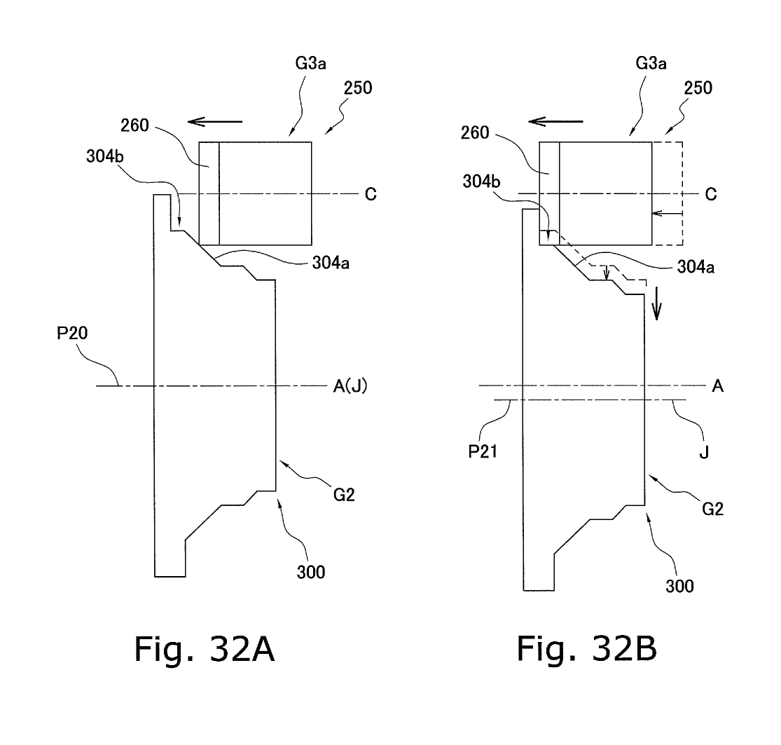

As shown in FIG. 31B, when the second retractable lens frame 300 is disposed at the reference position P20, the optical axis J of the second lens group G2 substantially coincides with the optical axis A of the optical system O. A state in which “the optical axis J of the second lens group G2 substantially coincides with the optical axis A of the optical system O” as here includes not only a state in which the optical axis J completely coincides with the optical axis A, but also a state in which the optical axis J is offset from the optical axis A to an extent that is permissible by the optical design.

As shown in FIGS. 30A and 30B, when the second retractable lens frame 300 is disposed at the offset position P21, the optical axis J of the second lens group G2 is offset in the Z axis direction from the optical axis A of the optical system O. Furthermore, the second lens frame body 393 supports the second retractable lens frame 300 integrally movably in the Y axis direction.

(1) Second Lens Frame Body 393

As shown in FIG. 29, the second lens frame body 393 has a substantially cylindrical base portion 399, three rectilinear projections 191, three cam followers 192, a first guide portion 398, a second guide portion 397, two first restricting projections 394a, two second restricting projections 394b, a first spring support portion 396a, and a second spring support portion 396b.

The rectilinear projections 191 are flat projections that extend in the Y axis direction from the outer peripheral part of the base portion 399, and are disposed at positions corresponding to the rectilinear grooves 84 of the rectilinear frame 80. The three rectilinear projections 191 are disposed at a substantially constant pitch in the circumferential direction. The rectilinear projections 191 and the rectilinear grooves 84 of the rectilinear frame 80 allow the second lens frame 190 to move in the Y axis direction without rotating with respect to the rectilinear frame 80.

As shown in FIG. 29, the cam followers 192 protrude outward in the radial direction from the ends of the rectilinear projections 191 (more precisely, the ends on the Y axis direction negative side). The cam followers 192 are fitted into the third cam grooves 74 of the rotary cam frame 70.

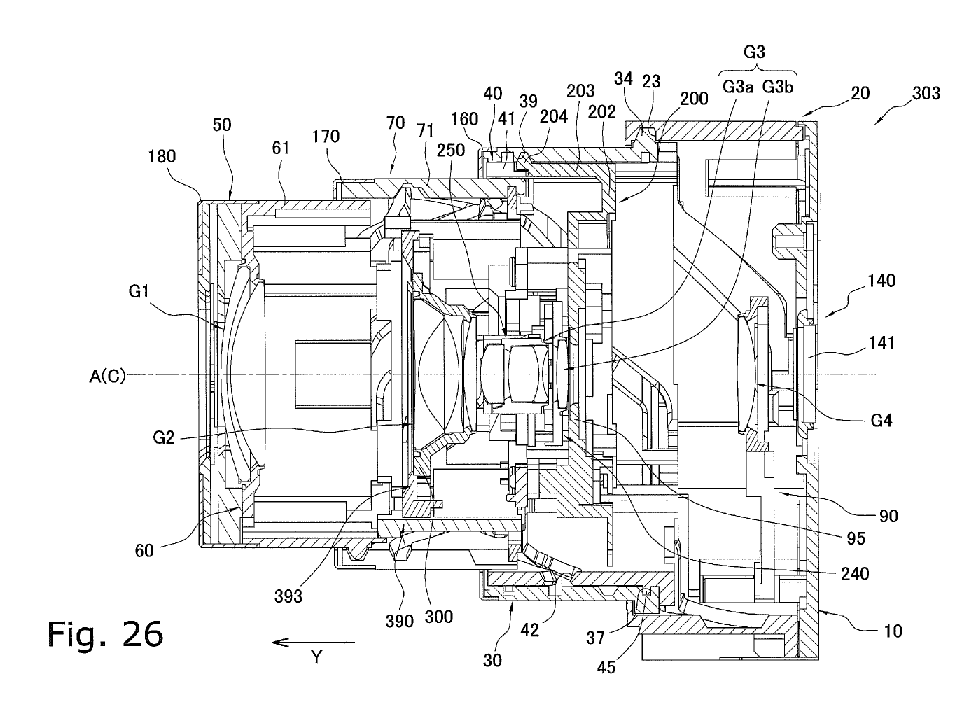

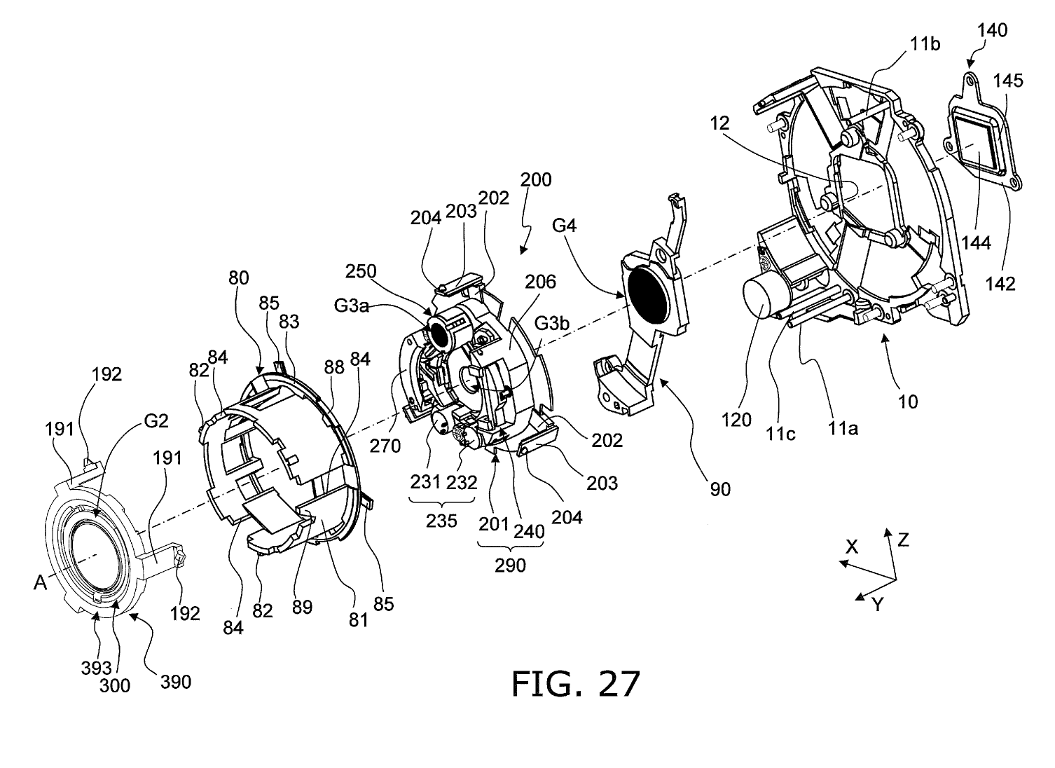

The rectilinear projections 191 and the cam followers 192 allow the second lens frame 390 to move in the Y axis direction with respect to the fixed frame 20, according to the shape of the third cam grooves 74, without rotating with respect to the fixed frame 20. In the retracted state shown in FIG. 24, the second lens frame 390 is closest to the third lens frame 200, as opposed to the state shown in FIGS. 25 and 26.

As shown in FIG. 29, the first guide portion 398 is a substantially annular portion extending to the inner peripheral side from the base portion 399, and supports the second retractable lens frame 300 movably in the Z axis direction. More specifically, the first guide portion 398 has four guide projections 395. The four guide projections 395 protrude substantially inward in the radial direction. More precisely, two of the guide projections 395 protrude to the X axis direction positive side, and two protrude to the X axis direction negative side. The guide projections 395 hit a pair of sliding faces 302a (discussed below) of the second retractable lens frame 300. The second retractable lens frame 300 is supported by the guide projections 395 movably in the Z axis direction with respect to the second lens frame body 393. Also, the guide projections 395 restrict rotation of the second retractable lens frame 300 around the optical axis A with respect to the second lens frame body 393.

As shown in FIG. 29, the second guide portion 397 is a plate-shaped portion extending further to the inner peripheral side from the first guide portion 398, and is formed in an arc shape along the inner side of the first guide portion 398. The thickness of the first guide portion 398 is greater than the thickness of the second guide portion 397, so the first guide portion 398 and the second guide portion 397 form an accommodation portion 330 in which the second retractable lens frame 300 is movably accommodated. The second guide portion 397 restricts movement of the second retractable lens frame 300 to the Y axis direction positive side with respect to the second lens frame body 393. When the second retractable lens frame 300 moves in the Z axis direction with respect to the second lens frame body 393, the second guide portion 397 slides with the second retractable lens frame 300.

As shown in FIG. 29, the two first restricting projections 394a protrude inward in the radial direction from the first guide portion 398, and are inserted into concave portions 301a of the second retractable lens frame 300. The first restricting projections 394a restrict movement of the second retractable lens frame 300 to the Y axis direction negative side with respect to the second lens frame body 393, and prevent the second retractable lens frame 300 from falling out of the second lens frame body 393.

As shown in FIG. 29, the first restricting projections 394a each have a positioning face 394e. The positioning faces 394e face inward in the radial direction, and come into contact with the second retractable lens frame 300 in the radial direction. The second retractable lens frame 300 is pressed against the two positioning faces 394e by the leaf spring 310. When the second retractable lens frame 300 is being pressed against the positioning faces 394e, the second retractable lens frame 300 is disposed at the reference position P20.

The two second restricting projections 394b protrude substantially inward in the radial direction, and come into contact in the Y axis direction with prongs 301b (discussed below) on the second retractable lens frame 300. The second restricting projections 394b restrict movement of the second retractable lens frame 300 to the Y axis direction negative side with respect to the second lens frame body 393, and prevent the second retractable lens frame 300 from falling out of the second lens frame body 393. The prongs 301b are inserted in between the second guide portion 397 and the second restricting projections 394b, so the second retractable lens frame 300 is guided in the Z axis direction with respect to the second lens frame body 393 by the second guide portion 397 and the second restricting projections 394b.

As shown in FIGS. 30B and 31B, the first restricting projections 394a are disposed on the Z axis direction positive side with respect to the optical axis A of the optical system O, and the second restricting projections 394b are disposed on the Z axis direction negative side with respect to the optical axis A of the optical system O. The two first restricting projections 394a and the two second restricting projections 394b are disposed to surround the second lens group G2, so the orientation of the second retractable lens frame 300 with respect to the second lens frame body 393 is stable.

The first spring support portion 396a and the second spring support portion 396b support the leaf spring 310. More specifically, as shown in FIGS. 30B, 29, and 31B, the first spring support portion 396a is disposed near the second restricting projections 394b, and supports a first end 310a of the leaf spring 310. The second spring support portion 396b is disposed near the second restricting projections 394b, and supports a second end 310b of the leaf spring 310.

(2) Second Retractable Lens Frame 300

The second retractable lens frame 300 is supported by the second lens frame body 393 movably in a direction (the Z axis direction in this embodiment) perpendicular to the optical axis A of the optical system O. More specifically, as shown in FIG. 29, the second retractable lens frame 300 has a substantially annular frame body 305, a pair of sliding portions 302, a pair of prongs 301b, a spring contact portion 309, a pair of concave portions 301a, a retraction cam face 304a (an example of a guide surface), and a retraction concave portion 304b.

The second lens group G2 is fixed to the frame body 305. The frame body 305 comes into contact with the second guide portion 397 in the Y axis direction. When the second retractable lens frame 300 moves in the Z axis direction with respect to the second lens frame body 393, the frame body 305 slides with the second guide portion 397.

The pair of sliding portions 302 protrude in the X axis direction from the frame body 305. The sliding portions 302 are disposed on either side of the frame body 305 in the X axis direction, with the optical axis J of the second lens group G2 in between. The sliding portions 302 have the sliding faces 302a extending in the Z axis direction. The sliding faces 302a come into contact with two guide projections 395. When the second retractable lens frame 300 moves in the Z axis direction with respect to the second lens frame body 393, the sliding faces 302a of the sliding portions 302 slide with the guide projections 395.

The prongs 301b are disposed on the Z axis direction negative side of the sliding portions 302, and protrude in the X axis direction from the frame body 305. Since the prongs 301b are inserted in between the second guide portion 397 and the second restricting projections 394b, movement of the second retractable lens frame 300 in the Y axis direction with respect to the second lens frame body 393 is restricted. When the second retractable lens frame 300 moves in the Z axis direction with respect to the second lens frame body 393, the prongs 301b slide with either the second guide portion 397 or the second restricting projections 394b. A cut-out 306 is formed between the prongs 301b and the sliding portions 302 to aid assembly of the second retractable lens frame 300 and the second lens frame body 393. When the second retractable lens frame 300 is attached to the second lens frame body 393, the second restricting projections 394b of the second lens frame body 393 pass through the cut-out 306, and this prevents the second retractable lens frame 300 from interfering with the second lens frame body 393.

The lens barrel 303 protrudes to the Y axis direction negative side from the frame body 305, and comes into contact with the leaf spring 310 in the Z axis direction. The concave portions 301a are disposed at positions corresponding to the first restricting projections 394a of the second lens frame body 393. The first restricting projections 394a are inserted into the concave portions 301a. In a state in which the outer peripheral edge 305a of the frame body 305 around the concave portions 301a is in contact with the positioning faces 394e of the first restricting projections 394a, the second retractable lens frame 300 is disposed at the reference position P20 with respect to the second lens frame body 393.

In this embodiment, the retractable lens frame 250 is used to retract the second retractable lens frame 300 to the offset position P21. Accordingly, the retraction cam face 304a is formed on the second retractable lens frame 300. The retraction cam face 304a is provided slidably with the retractable lens frame 250. In this embodiment, when the lens barrel 303 is being retracted, the aperture cap 260 attached to the retractable lens frame 250 slides with the retraction cam face 304a (see FIG. 30A).

More specifically, as shown in FIG. 31B, when viewed in the Y axis direction, in a state in which the retractable lens frame 250 is disposed at the first retraction position P1, part of the aperture cap 260 of the retractable lens frame 250 overlaps the retraction cam face 304a. More precisely, when viewed in the Y axis direction, part of the outer peripheral edge of the aperture cap 260 overlaps the retraction cam face 304a.

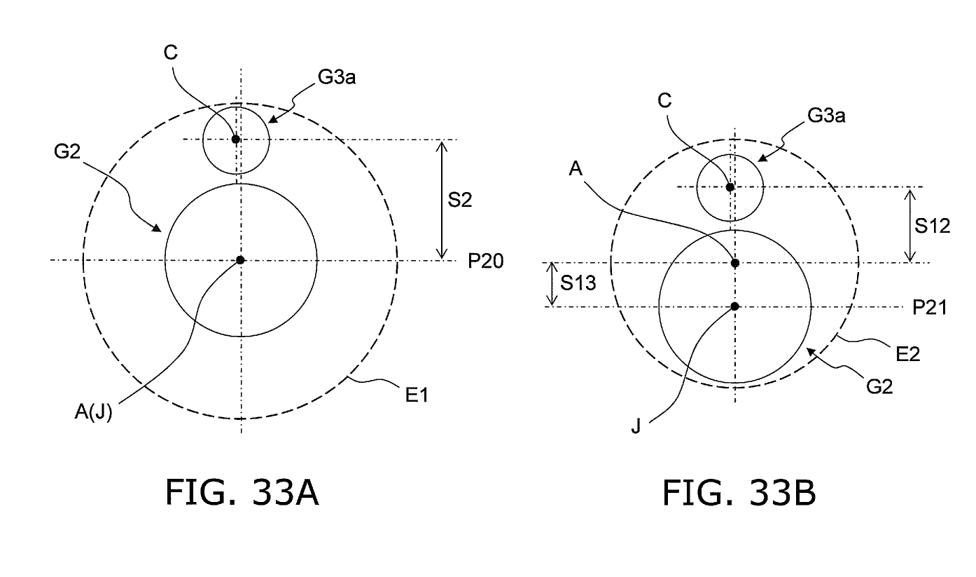

As shown in FIGS. 32A and 32B, when the retraction cam face 304a is pushed by the retractable lens frame 250, the second retractable lens frame 300 retracts to the Z axis direction negative side. More specifically, the retraction cam face 304a is inclined with respect to the optical axis J of the second lens group G2. It can also be said that the retraction cam face 304a is inclined with respect to the optical axis A of the optical system O. The retraction cam face 304a is formed annularly to surround the second lens group G2, and is inclined to the Y axis direction negative side going toward the outside in the radial direction. When the retractable lens frame 250 approaches the second retractable lens frame 300 and pushes the retraction cam face 304a to the Y axis direction positive side, the second retractable lens frame 300 moves to the Z axis direction negative side with respect to the second lens frame body 393. That is, the retractable lens frame 250 drives the second retractable lens frame 300 to the offset position P21 (see FIGS. 30B and 32B). In this embodiment, the reference position P20 and the offset position P21 are defined using the optical axis J of the second lens group G2 as a reference.

The retraction concave portion 304b is recessed in an arc shape formed in the frame body 305, and is disposed on the Z axis direction positive side of the second lens group G2. As shown in FIG. 30A, when the lens barrel 303 is in the retracted state, part of the aperture cap 260 of the retractable lens frame 250 is inserted in the retraction concave portion 304b. Since the second retractable lens frame 300 is pushed by the leaf spring 310 to the Z axis direction positive side, the face 304c of the retraction concave portion 304b comes into contact with the retractable lens frame 250. Since the face 304c of the retraction concave portion 304b is not inclined with respect to the optical axis J of the second lens group G2, even if the face 304c of the retraction concave portion 304b comes into contact with the retractable lens frame 250, no force is generated that would push the retractable lens frame 250 to the Y axis direction negative side. Therefore, in a state in which the retractable lens frame 250 is disposed at the second retraction position P2, the positions of the retractable lens frame 250 and the second retractable lens frame 300 are stable.

(3) Leaf Spring 310

The leaf spring 310 is attached to the second lens frame body 393, and supports the second retractable lens frame 300 at the reference position P20 with respect to the second lens frame body 393. More specifically, as shown in FIG. 29, the leaf spring 310 extends in a slender form in the Y axis direction, and has a first end 310a and a second end 310b. The first end 310a is attached to the first spring support portion 396a. The second end 310b is attached to the second spring support portion 396b. As shown in FIGS. 30A and 30B, when the lens barrel 303 is in the retracted state, the leaf spring 310 is disposed on the opposite side from the retractable lens frame 250 with respect to the second lens group G2.

As shown in FIG. 31B, the leaf spring 310 comes into contact with the lens barrel spring contact portion 309. In a state in which the second retractable lens frame 300 is disposed at the reference position P20, the leaf spring 310 bends in the Z axis direction. The leaf spring 310 exerts an elastic force F1 in the Z axis direction on the second retractable lens frame 300, and presses the second retractable lens frame 300 against the second lens frame body 393 in the Z axis direction. The outer peripheral edge 305a of the second retractable lens frame 300 is pressed by the leaf spring 310 against the positioning faces 394e of the first restricting projections 394a. Consequently, the second retractable lens frame 300 can be held at the reference position P20 with respect to the second lens frame body 393.

When a force greater than the elastic force F1 is exerted on the second retractable lens frame 300 to the Z axis direction negative side, the second retractable lens frame 300 moves to the Z axis direction negative side with respect to the second lens frame body 393 against the elastic force F1 of the leaf spring 310. In a state in which the retractable lens group G3a has retracted to the second retraction position P2, the retractable lens frame 250 is in contact with the second retractable lens frame 300, and the second retractable lens frame 300 is pressed against the retractable lens frame 250 by the leaf spring 310. The offset position P21 corresponds to the position of the second retractable lens frame 300 at this point. It could also be said that the retractable lens frame 250 pushes the second retractable lens frame 300 to the Z axis direction negative side. As shown in FIG. 30A, in a state in which the retractable lens group G3a has retracted to the second retraction position P2, part of the retractable lens group G3a is disposed on the outer peripheral side of the second lens group G2.

The method for assembling the second lens frame 390 here will be described through reference to FIGS. 31A and 31B. As shown in FIG. 31A, the second retractable lens frame 300 is attached to the second lens frame body 393 in a state in which the center of the second retractable lens frame 300 (more precisely, the optical axis J of the second lens group G2) is offset to the Z axis direction negative side with respect to the center of the second lens frame body 393 (the optical axis A of the optical system O). More specifically, the second retractable lens frame 300 is attached in the Y axis direction to the second lens frame body 393 so that the second restricting projections 394b are inserted into the cut-out 306.

Furthermore, in a state in which the second retractable lens frame 300 is in contact with the second guide portion 397, the second retractable lens frame 300 is slid to the Z axis direction positive side with respect to the second lens frame body 393. As a result, the first restricting projections 394a are inserted into the concave portions 301a, and the prongs 301b are inserted between the second restricting projections 394b and the second guide portion 397. In a state in which the second retractable lens frame 300 is disposed at the offset position P21, the prongs 301b are disposed between the second restricting projections 394b and the second guide portion 397.

As shown in FIG. 31B, the leaf spring 310 is attached to the second lens frame body 393 in a state in which the outer peripheral edge 305a of the second retractable lens frame 300 is pressed against the second restricting projections 394b of the second lens frame 390. More specifically, the leaf spring 310 is bent in the Z axis direction while the first end 310a and the second end 310b of the leaf spring 310 are inserted into the first spring support portion 396a and the second spring support portion 396b, respectively, of the second lens frame body 393. The second lens frame 390 is assembled in this way.

### 2: Operation

The operation of the digital camera 1 will be described through reference to FIGS. 1 to 3.

2.1: When Power is Off When the power switch 6 is in its off state, the lens barrel 303 is stopped in its retracted position (the state in which the lens barrel 303 is at its shortest in the Y axis direction; the state shown in FIG. 24), so that the lens barrel 303 will fit within the external dimensions of the housing 2 in the Y axis direction.

In this state, just as in the first embodiment, the rectilinear restriction face 86b of the rectilinear frame 80 pushes the drive projection 255 of the retractable lens frame 250 to the R4 side around the center axis B of the rotary shaft 224. Accordingly, the retractable lens group G3a is stopped at the retracted position at which the optical axis C is away from the optical axis A by a retraction amount S12 (see FIGS. 30A and 30B). Also, the end face 86c of the rectilinear frame 80 holds the drive projection 255 of the retractable lens frame 250 down to the Y axis direction negative side. Consequently, in this state (see FIG. 20A, for example), the distance between the retractable lens frame 250 and the shutter unit 230 is shorter by the movement amount S1 than in the imaging state (see FIG. 25).

As shown in FIGS. 30A and 30B, the aperture cap 260 of the retractable lens frame 250 comes into contact substantially in the Z axis direction with the face 304c of the retraction concave portion 304b of the second retractable lens frame 300. The elastic force F1 of the leaf spring 310 presses the second retractable lens frame 300 against the retractable lens frame 250, and the second retractable lens frame 300 is held at the offset position P21. The retractable lens frame 250 is in contact with the concave portion 86d of the rectilinear frame 80, and is sandwiched between the rectilinear frame 80 and the second retractable lens frame 300. In a state in which the second retractable lens frame 300 is held at the offset position P21, the optical axis J of the second lens group G2 is offset by a retraction amount S13 from the optical axis A of the optical system O to the Z axis direction negative side. When viewed in the Y axis direction, the retractable lens group G3a is disposed on the outer peripheral side of the second lens group G2. Part of the retractable lens group G3a enters on the outer peripheral side of the second lens group G2.

2.2: Operation When Power is On

When the power switch 6 is switched on, power is supplied to the various components, and the lens barrel 303 is driven from its retracted state to its imaging state. More specifically, the drive frame 30 is driven by the zoom motor unit 110 by a specific angle to the R2 side with respect to the fixed frame 20. As a result, the drive frame 34 rotates with respect to the fixed frame 20 while moving to the Y axis direction positive side with respect to the fixed frame 20.

When the drive frame 30 moves in the Y axis direction while rotating with respect to the fixed frame 20, the first rotary projections 43 and the second rotary projections 45 cause the camera cam frame 40 to move in the Y axis direction integrally with the drive frame 30. At this point the rectilinear protrusions 47a to 47c of the camera cam frame 40 are guided in the Y axis direction by the rectilinear grooves 27a to 27c of the fixed frame 20, so the camera cam frame 40 moves in the Y axis direction integrally with the drive frame 30 without rotating with respect to the fixed frame 20 (see FIGS. 12A and 12B).

Also, as shown in FIG. 14, since the distal ends 76b of the cam followers 76 of the rotary cam frame 70 are fitted into the rectilinear grooves 38 of the drive frame 30, the rotary cam frame 70 rotates along with the drive frame 30 with respect to the fixed frame 20. As a result, the rotary cam frame 70 and the camera cam frame 40 rotate relatively. Since the cam followers 76 of the rotary cam frame 70 pass through the cam through-grooves 42 of the camera cam frame 40, when the rotary cam frame 70 rotates with respect to the camera cam frame 40, the rotary cam frame 70 moves in the Y axis direction while rotating with respect to the fixed frame 20 and the camera cam frame 40, according to the shape of the cam through-grooves 42.

The rectilinear frame 80 is provided integrally movably in the Y axis direction and rotatably with respect to the rotary cam frame 70, and the rectilinear frame 80 is provided movably in the Y axis direction without rotating with respect to the camera cam frame 40. More specifically, the rotary projections 83 of the rectilinear frame 80 are inserted into the rotary grooves 77 of the rotary cam frame 70, and the second rectilinear projections 85 of the rectilinear frame 80 are inserted into the rectilinear grooves 46 of the camera cam frame 40. With this configuration, when the rotary cam frame 70 moves in the Y axis direction while rotating with respect to the fixed frame 20, the rectilinear frame 80 moves in the Y axis direction integrally with the rotary cam frame 70 without rotating with respect to the camera cam frame 40 and the fixed frame 20.

Furthermore, when the rotary cam frame 70 rotates with respect to the fixed frame 20, the first cam followers 68 are guided in the Y axis direction by the first cam grooves 72 of the rotary cam frame 70. Accordingly, the first lens frame 60 moves in the Y axis direction with respect to the rotary cam frame 70 and the rectilinear frame 80. At this point, since the first rectilinear grooves 63 of the first lens frame 60 are inserted into the first rectilinear projections 82 of the rectilinear frame 80, the first lens frame 60 moves in the Y axis direction without rotating with respect to the rectilinear frame 80. Therefore, the first lens frame 60 moves in the Y axis direction without rotating with respect to the fixed frame 20 (while rotating with respect to the 70), according to the shape of the first cam grooves 72. Since a gap is ensured between the second cam followers 69 and the second cam grooves 73 at this point, the second cam followers 69 move through the second cam grooves 73 without touching the second cam grooves 73.

Also, the cam followers 192 of the second lens frame 390 are fitted into the third cam grooves 74 of the rotary cam frame 70. Since the rectilinear projections 191 of the second lens frame 390 are inserted into the second rectilinear grooves 64 of the first lens frame 60, the second lens frame 390 moves in the Y axis direction without rotating with respect to the first lens frame 60. With this configuration, the second lens frame 390 moves in the Y axis direction according to the shape of the third cam grooves 74, without rotating with respect to the camera cam frame 40 and the fixed frame 20.

Also, since the rectilinear projections 203 of the third lens frame 200 are inserted into the rectilinear through-grooves 48 of the camera cam frame 40, the third lens frame 200 is movable in the Y axis direction without rotating with respect to the fixed frame 20 and the camera cam frame 40. Further, the cam followers 204 are fitted into the cam grooves 39 of the drive frame 30. With this configuration, the third lens frame 200 moves in the Y axis direction according to the shape of the cam grooves 39, without rotating with respect to the camera cam frame 40 and the fixed frame 20. As shown in FIGS. 24 and 25, when drive is performed by the zoom motor unit from the retracted state to the imaging state, the drive frame 30 moves to the Y axis direction positive side while rotating with respect to the fixed frame 20, but the third lens frame 200 moves to the Y axis direction negative side with respect to the 30. Accordingly, the third lens frame 200 moves to the Y axis direction positive side with respect to the fixed frame 20, but the movement amount of the third lens frame 200 with respect to the fixed frame 20 is suppressed.

At this point the second lens frame 390 and the third lens frame 200 are moving away from each other in the Y axis direction, so the retractable lens frame 250 and the second retractable lens frame 300 are gradually moving away from each other in the Y axis direction. As a result, the aperture cap 260 of the retractable lens frame 250 comes out of the retraction concave portion 304b and slides with the retraction cam face 304a of the second retractable lens frame 300 while the retractable lens frame 250 moves to the Y axis direction negative side with respect to the second retractable lens frame 300.

Since the second retractable lens frame 300 is pushed by the leaf spring 310 to the Z axis direction positive side, the retraction cam face 304a is pressed against the retractable lens frame 250. Since the retraction cam face 304a is inclined with respect to the optical axes A and J, when the retractable lens frame 250 moves to the Y axis direction negative side with respect to the second retractable lens frame 300, the second retractable lens frame 300 moves to the Z axis direction positive side with respect to the second lens frame body 393 according to the inclination of the retraction cam face 304a. When the retractable lens frame 250 moves away from the second retractable lens frame 300, the outer peripheral edge 305a of the second retractable lens frame 300 hits the positioning faces 394e of the second lens frame body 393. This returns the position of the second retractable lens frame 300 with respect to the second lens frame body 393 to the reference position P20.

Since the second rectilinear projections 85 of the rectilinear frame 80 are inserted into the rectilinear grooves 46 of the camera cam frame 40, the rectilinear frame 80 is movable in the Y axis direction without rotating with respect to the fixed frame 20 and the camera cam frame 40. Further, since the rotary projections 83 of the rectilinear frame 80 are meshed with the rotary projections 75 of the rotary cam frame 70, the rectilinear frame 80 moves in the Y axis direction along with the rotary cam frame 70 in a state in which relative rotation is permitted. When the drive frame 30 rotates with respect to the fixed frame 20, the rotary cam frame 70 rotates with respect to the camera cam frame 40, and the cam followers 76 of the rotary cam frame 70 are guided by the cam through-grooves 42 of the camera cam frame 40. Consequently, the rectilinear frame 80 moves in the Y axis direction along with the rotary cam frame 70 without rotating with respect to the fixed frame 20 and the camera cam frame 40. More specifically, the rectilinear frame 80 moves to the Y axis direction positive side along with the rotary cam frame 70 without rotating with respect to the fixed frame 20. The movement amount of the rectilinear frame 80 with respect to the fixed frame 20 here is greater than the movement amount of the third lens frame 200 with respect to the fixed frame 20, so in the course of switching the lens barrel 303 from its retracted state to an imaging state, the rectilinear frame 80 moves away from the third lens frame 200 to the Y axis direction positive side.

When the rectilinear frame 80 thus moves away from the third lens frame 200, the retractable lens frame 250 moves to the Y axis direction positive side along with the rectilinear frame 80 in a state in which the drive projection 255 is pressed against the end face 86c. At this point the retractable lens frame 250 moves to the Y axis direction positive side with respect to the base frame 201. When the retractable lens frame 250 hits the retraction main axis cover 270, movement of the retractable lens frame 250 in the Y axis direction with respect to the base frame 201 comes to a stop, and the rectilinear frame 80 moves away from the retractable lens frame 250 to the Y axis direction positive side.

When the rectilinear frame 80 moves away from the retractable lens frame 250 to the Y axis direction positive side, the drive projection 255 of the retractable lens frame 250 moves to the inclined face 86a while sliding with the rectilinear restriction face 86b of the rectilinear frame 80, and further slides with the inclined face 86a. At this point the drive projection 255 is pressed against the inclined face 86a by the torsion force of the torsion compression coil spring 258, so the retractable lens frame 250 rotates to the R3 side, going from the first retraction position P1 to the insertion position P0, according to the shape of the inclined face 86a. The retractable lens frame 250 is positioned where the positioning projection 256 hits the stopper 205 (that is, at the insertion position P0) by the torsion force of the torsion compression coil spring 258 (see FIGS. 19B and 20B). At the insertion position P0, the optical axis C of the retractable lens group G3a substantially coincides with the optical axis A of the optical system O.

2.3: Operation when Power is Off

Meanwhile, when the power switch 6 is switched off, the lens barrel 303 is driven from an imaging state to a retracted state. More specifically, the drive frame 30 is driven by the zoom motor unit 110 by a specific angle to the R1 side with respect to the fixed frame 20. As a result, the lens barrel 303 operates in the reverse order from that in the operation when the power is on as discussed above.

For example, during retraction operation, since the rectilinear frame 80 and the third lens frame 200 move closer to each other, the drive projection 255 of the retractable lens frame 250 is guided by the inclined face 86a of the rectilinear frame 80. More specifically, the retractable lens frame 250 is rotationally driven by the inclined face 86a to the R4 side (see FIG. 19A). When the retractable lens frame 250 reaches the first retraction position P1, the drive projection 255 reaches the end face 86c while sliding with the rectilinear restriction face 86b, and the drive projection 255 is pushed by the end face 86c to the Y axis direction negative side. As a result, the drive projection 255 is driven by the rectilinear frame 80 to the Y axis direction negative side with respect to the base frame base frame 201, and the retractable lens frame 250 reaches the second retraction position P2.

Meanwhile, since the second lens frame 390 and the third lens frame 200 gradually move closer to each other in the Y axis direction, in a state in which the retractable lens frame 250 is disposed at the second retraction position P2, the retractable lens frame 250 moves closer to the second retractable lens frame 300 of the second lens frame 390 in the Y axis direction. As a result, the aperture cap 260 of the retractable lens frame 250 touches the retraction cam face 304a of the frame body 305 of the second retractable lens frame 300, and the retraction earn face 304a is pushed in the Y axis direction by the retractable lens frame 250. When the retraction cam face 304a is pushed in the Y axis direction by the retractable lens frame 250, the second retractable lens frame 300 is driven to the Z axis direction negative side with respect to the second lens frame body 393 according to the inclination of the retraction cam face 304a. When the second retractable lens frame 300 reaches the offset position P21, the retractable lens frame 250 is inserted into the retraction concave portion 304b, and the retractable lens frame 250 hits the face 304c of the retraction concave portion 304b. In this state, since the second retractable lens frame 300 is being pressed against the retractable lens frame 250 by the leaf spring 310, the second retractable lens frame 300 is held at the offset position P21 with respect to the second lens frame body 393.

In a state in which the second lens group G2 has come into close proximity with the correction lens group G3b in the Y axis direction, the relative movement between the second lens frame 390 and the third lens frame 200 in the Y axis direction stops.

Thus, when the power is off, with this lens barrel 303, after the retractable lens frame 250 retracts to the second retraction position P2, the second retractable lens frame 300 further retracts to the offset position P21, and finally the retracted state shown in FIG. 24 is reached.

### 2: Features of Lens Barrel

2.1 As described above, in the retracted state shown in FIG. 24, part of the retractable lens group G3a is disposed on the outer peripheral side of the second lens group G2 in a state in which the retractable lens group G3a has retracted to the second retraction position P2. Therefore, with this lens barrel 303, the second lens group G2 can be moved closer to the correction lens group G3b in a retracted state, which affords a more compact size.

2.2 Furthermore, as shown in FIGS. 30A and 30B, with this lens barrel 303, the second retractable lens frame 300 is disposed at the offset position P21 at which the optical axis J of the second lens group G2 is offset from the optical axis A of the optical system O in a state in which the retractable lens group G3a has retracted to the second retraction position P2. Therefore, the position of the retractable lens group G3a can be closer to the optical axis A of the optical system O than when the second retractable lens frame 300 is disposed at the reference position P20 at which the optical axis J of the second lens group G2 coincides with the optical axis A of the optical system O.

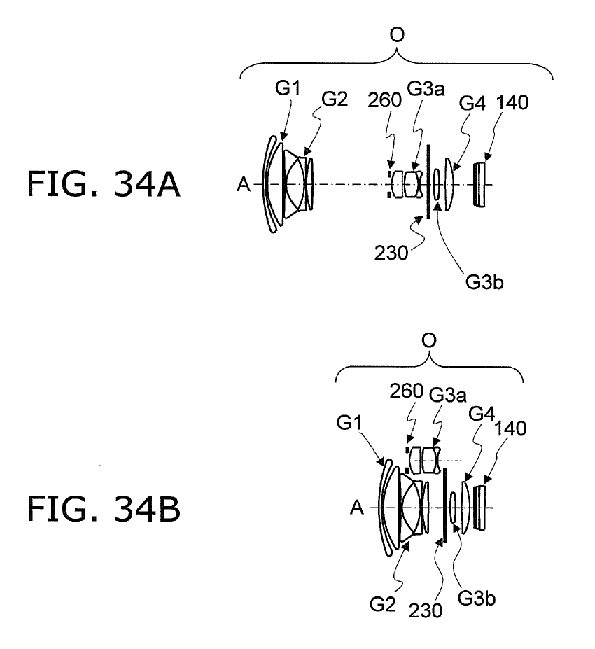

For instance, as shown in FIG. 33A, when the retractable lens group G3a is retracted to the outer peripheral side of the second lens group G2 in a state in which the second lens group G2 is disposed at the reference position P20, the retractable lens group G3a must be moved from the center by a retraction amount S2 (this corresponds to the first embodiment).

However, as shown in FIG. 33B, the retraction amount S12 can be made shorter than the retraction amount S2 by retracting the second lens group G2 to the offset position P21.

As shown in FIG. 33A, the smallest imaginary circular that includes both the second lens group G2 and the retractable lens group G3a, and whose center is the optical axis A of the optical system O, is like a circle E1, but an imaginary circle in the case shown in FIG. 33B is like a circle E2, and the circle E2 can be made smaller than the circle E1 by retracting the second retractable lens frame 300.

Since the second lens group G2 is thus retracted to the offset position P21 with this lens barrel 303, this is advantageous in terms of reducing the size in the radial direction.

2.3 As shown in FIGS. 30A and 30B, in a state in which the second retractable lens frame 300 is disposed at the offset position P21, the second retractable lens frame 300 hits the retractable lens frame 250. Sine the second retractable lens frame 300 is thus hitting the retractable lens frame 250, the retractable lens frame 250 can be moved as close as possible to the second retractable lens frame 300, and the lens barrel 303 can be made even more compact.

2.4 As shown in FIGS. 30A and 30B, in the imaging state of the lens barrel 303, the second retractable lens frame 300 is held at the reference position P20 by the leaf spring 310, and in the retracted state of the lens barrel 303, the second retractable lens frame 300 is pushed by the retractable lens frame 250 and is disposed at the offset position P21. Since the retractable lens frame 250 is thus used to move the second retractable lens frame 300 to the offset position P21, there is no need to provide a mechanism for moving the second retractable lens frame 300, so in addition to a smaller size, the structure can also be simplified.

The size of the lens barrel 303 can also be reduced with a configuration in which another retraction mechanism besides the retractable lens frame 250 is used to retract the second retractable lens frame 300.

### Other Embodiments

Embodiments of the present invention are not limited to those given above, and various changes and modifications are possible without departing from the gist of the invention. Those components having substantially the same function as those in the above embodiments are numbered the same as in the above embodiments, and will not be described in detail again.

(1) The constitution of the optical system O is not limited to that given above. For example, the various lens groups (the first lens group G1 to a fifth lens group G5 (discussed below)) can be constituted by a single lens, or can be constituted by a plurality of lenses.

(2) In the above embodiments, interference between the second lens frame body 193 and the retractable lens frame 250 in a retracted state is prevented by moving the retractable lens frame 250 with the rectilinear frame 80 by the movement amount S1 (see FIG. 20A) to the Y axis direction negative side. However, further reduction in the size of the lens barrel 3 is also possible when the retractable lens frame 250 is not moved in the Y axis direction.

(3) The positional relations between the retractable lens group G3a, the correction lens group G3b, the aperture cap 260, and the shutter unit 230 are not limited to those in the above embodiments.

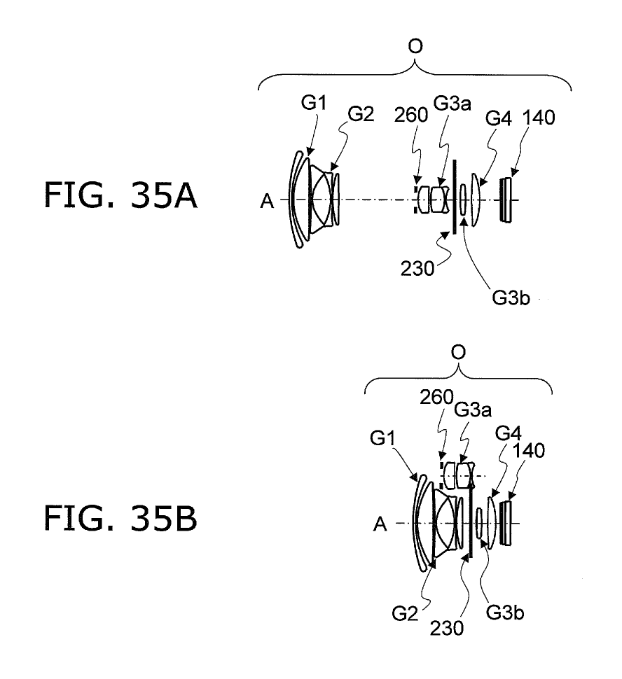

For example, as shown in FIGS. 34A and 34B, the shutter unit 230 can be disposed between the correction lens group G3b and the retractable lens group G3a. Just as in the above embodiments, the retractable lens group G3a and the aperture cap 260 are retracted out of the optical path in a retracted state. Since the retractable lens group G3a is disposed adjacent to the shutter unit 230, the retractable lens frame 250 is not moved in the retractable lens frame 250.

Here again, since the retractable lens group G3a is disposed adjacent to the aperture cap 260, the diameter of the retractable lens group G3a can be reduced. Consequently, less space is required to retract the retractable lens group G3a, and the diameter D of the lens barrel 3 can be increased while reducing the lens barrel thickness H.

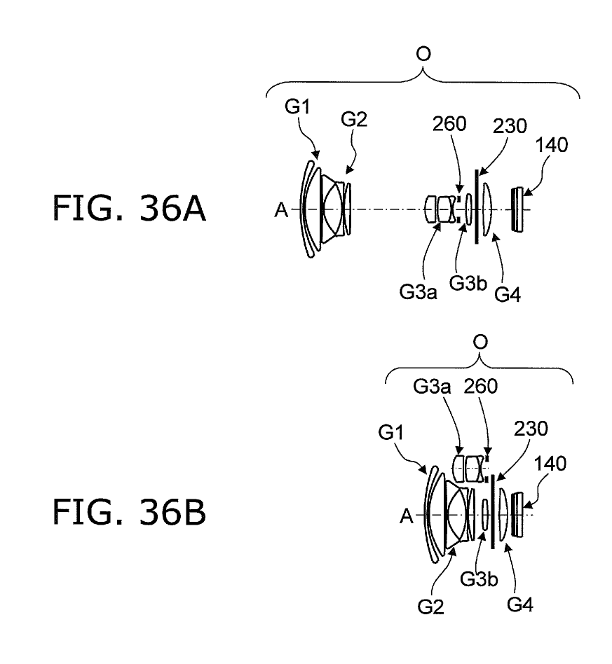

As shown in FIGS. 35A and 35B, just as in the above embodiments, the constitution can be such that the retractable lens group G3a is moved in the Y axis direction. In this case, for example, a cut-out for preventing interference with the retractable lens frame 250 can be arranged in the shutter unit 230. Providing a cut-out allows the lens barrel thickness H to be reduced as compared to the constitution shown in FIGS. 34A and 34B.

When a cut-out is arranged in the shutter unit 230, there is the possibility that unnecessary light rays will go through the cut-out and be incident on the CCD image sensor 141. Therefore, the constitution of the above embodiments (that shown in FIGS. 23A and 23B) is better than the constitution shown in FIGS. 35A and 35B in terms of optical performance.

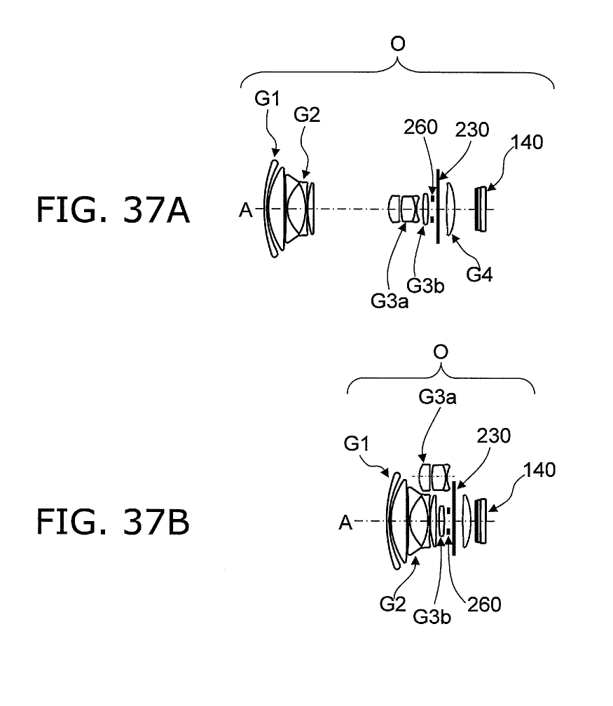

(4) Also, in the above embodiments, the aperture cap 260 is disposed in front of the retractable lens group G3a, but the aperture cap 260 can be disposed to the rear of the retractable lens group G3a. More specifically, the aperture cap 260 is disposed to the rear of the retractable lens group G3a as shown in FIGS. 36A and 36B. The retractable lens group G3a is disposed between the correction lens group G3b and the aperture cap 260. Just as in the above embodiments, the retractable lens group G3a and the aperture cap 260 are retracted out of the optical path in a retracted state.

In this case, since the aperture cap 260 is disposed between the correction lens group G3b and the retractable lens group G3a, the diameter of both the correction lens group G3b and the retractable lens group G3a can be reduced. This helps to make the lens barrel 3 more compact.

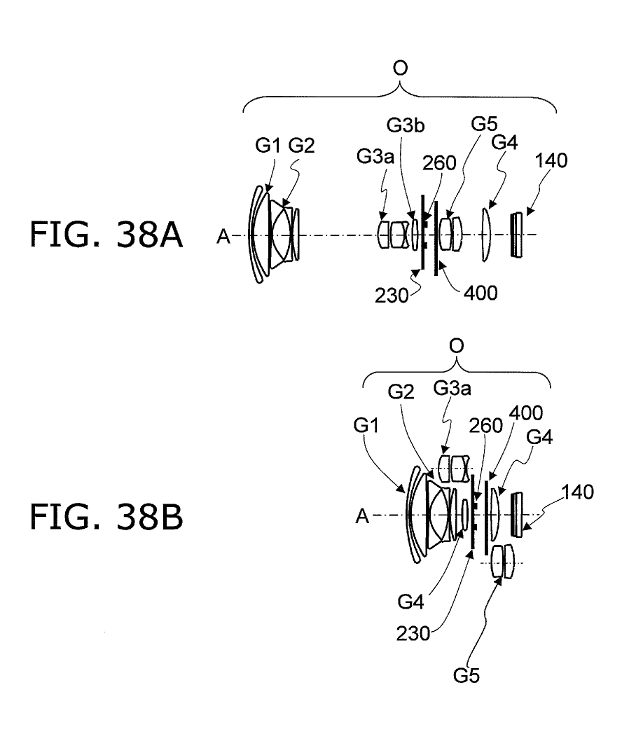

(5) As shown in FIGS. 37A and 37B, the aperture cap 260 can be disposed to the rear of the correction lens group G3b. With this configuration, the correction lens group G3b is disposed between the retractable lens group G3a and the aperture cap 260.

In this case, since the correction lens group G3b is disposed between the retractable lens group G3a and the aperture cap 260, the diameter of the correction lens group G3b can be reduced. This allows the drive correcting mechanism 289 to be smaller, and allows the lens barrel 3 to be made more compact.

(6) In the above embodiments, a four-group zoom configuration is employed in which four lens groups (the first lens group G1 to fourth lens group G4) move independently, but the configuration of the optical system O is not limited to that of the above embodiments. To impart a zoom function with an even higher zoom ratio, as shown in FIGS. 38A and 38B, a five-group zoom configuration can be employed in which five lens groups move independently in the Y axis direction. The fifth lens group G5 is disposed between the aperture cap 260 and the fourth lens group G4, and is supported by a fifth lens frame 400. The fifth lens group G5 is further supported by a second rectilinear lens frame (not shown), and when retracted, moves from the optical axis A to the retracted position just as with the retractable lens group G3a.

Thus, the lens group to be retracted is not limited to a single lens group, and a configuration can be employed in which a plurality of lens groups are retracted separately. Here again it is possible to make the lens barrel 3 more compact.

Also, with a five-group zoom configuration, the diameter of the retractable lens group G3a and the fifth lens group G5 can be reduced by disposing the lens groups so that the distance between the aperture cap 260 and the retractable lens group G3a, and the distance between the fifth lens group G5 and the correction lens group G3b are shorter. As a result, a smaller size is possible even with a lens barrel having a higher zooming function.

(7) The aperture cap 260 need not be a fixed stop, and can be an iris that allows the opening diameter to be changed.

(8) In the above embodiments, a digital still camera was described as an example of a device in which the lens barrel 3 is installed, but the device in which the lens barrel 3 is installed can be any device with which an optical image needs to be formed. Examples of devices in which the lens barrel 3 is installed include an imaging device capable of capturing only still pictures, an imaging device capable of capturing only moving pictures, and an imaging device capable of capturing both still and moving pictures.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member,” “unit” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the lens barrel or an imaging device equipped with the lens barrel. Accordingly, these terms, as utilized to describe the present invention should be interpreted relative to the lens barrel or the imaging device equipped with the lens barrel.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

What is claimed is:

1. A lens barrel comprising:
an optical system including a corrective lens group and a retractable lens group;
a support mechanism that movably supports the corrective lens group in a direction perpendicular to an optical axis of the optical system;
a drive correcting mechanism configured to drive the support mechanism so that the corrective lens group moves in a direction perpendicular to the optical axis of the optical system;
a retractable lens frame that retractably supports the retractable lens group to a first position in which the optical axis of the retractable lens group is offset from the optical axis of the optical system; and
a drive retracting mechanism configured to drive the retractable lens frame so that the retractable lens group retracts to the first position.

2. The lens barrel according to claim 1, wherein
the center thickness of the retractable lens group is greater than the center thickness of the corrective lens group.

3. The lens barrel according to claim 1, wherein
the retractable lens frame is rotatably supported by the support mechanism so as to be retracted to the outside of an optical path of the optical system.

4. The lens barrel according to claim 3, further comprising
a fixed frame defining an interior space that accommodates the corrective lens group and the retractable lens group when the lens barrel is in a retracted state, wherein
the support mechanism is movably disposed along the optical axis of the optical system relative to the fixed frame together with the retractable lens frame.

5. The lens barrel according to claim 3, wherein
the support mechanism includes a base frame and a corrective lens frame, the base frame movably supports movement of the corrective lens frame along a direction perpendicular to the optical axis of the optical system, the corrective lens group is fixed to the corrective lens frame and the retractable lens frame is rotatably supported by the base frame.

6. The lens barrel according to claim 5, wherein
the base frame rotatably and movably supports the retractable lens frame along the optical axis of the optical system, and
when the retractable lens frame is retracted, the drive retracting mechanism rotates the retractable lens frame to the first position and moves the retractable lens frame along the optical axis of the optical system from the first position to a second position.

7. The lens barrel according to claim 6, wherein
at least part of the retractable lens group is disposed on at least one of the outer peripheral side of corrective lens group and on the outer peripheral side of the corrective lens frame when the retractable lens group has retracted to the second position.

8. The lens barrel according to claim 5, wherein
when viewed along a direction parallel to the optical axis of the optical system, the retractable lens group is disposed on the outer peripheral side of the corrective lens frame when the retractable lens group is in the first position.

9. The lens barrel according to claim 8, wherein
when the lens barrel is in a retracted state, at least part of the retractable lens group is disposed within a range in which the corrective lens frame is movable.

10. The lens barrel according to claim 1, further comprising
a shutter unit configured to adjust the exposure time of an imaging sensor, wherein
the shutter unit is supported by the support mechanism.

11. The lens barrel according to claim 10, wherein
the corrective lens group is disposed between the retractable lens group and the shutter unit.

12. The lens barrel according to claim 1, further comprising
an aperture configured to determine the aperture value of the optical system, wherein
at least one of the corrective lens group and the retractable lens group being disposed adjacent to the aperture.

13. The lens barrel according to claim 12, wherein
the aperture is fixed to the retractable lens frame together with the retractable lens group.

14. The lens barrel according to claim 12, wherein
the retractable lens group is disposed between the aperture and the corrective lens group.

15. The lens barrel according to claim 12, wherein
the aperture is disposed between the corrective lens group and the retractable lens group.

16. The lens barrel according to claim 12, wherein
the corrective lens group is disposed between the retractable lens group and the aperture.

17. The lens barrel according to claim 1, wherein
the drive correcting mechanism includes a first drive correcting unit and a second drive correcting unit, the first drive correcting unit is configured to drive the support mechanism so that the corrective lens group moves in a first direction perpendicular to the optical axis of the optical system, and the second drive correcting unit is configured to drive the support mechanism so that the corrective lens group moves in a second direction that is perpendicular to the first direction and to the optical axis of the optical system, and
when viewed along a direction parallel to the optical axis of the optical system, the retractable lens group does not overlap the first drive correcting unit and the second drive correcting unit when the retractable lens group is disposed at the first position.

18. The lens barrel according to claim 17, wherein
when viewed along the direction of the optical axis of the optical system, the corrective lens group is disposed between the first drive correcting unit and the second drive correcting unit along a third direction perpendicular to the optical axis of the optical system, and
when viewed along the direction of the optical axis of the optical system, the retractable lens group is aligned with the corrective lens group along a fourth direction perpendicular to the third direction and the optical axis of the optical system when the retractable lens group has retracted to the outside of the optical path of the optical system.

19. The lens barrel according to claim 18, further comprising
a shutter unit configured to adjust the exposure time of an imaging sensor; and
a shutter drive mechanism configured to drives the shutter unit, wherein
when viewed along the direction of the optical axis of the optical system, the corrective lens group is disposed between the shutter drive mechanism and the retractable lens group which has retracted to the outside of the optical path.

20. The lens barrel according to claim 1, further comprising
a lens support frame movably disposed along the optical axis of the optical system relative to the retractable lens frame, wherein
the optical system further includes a shift lens group attached to the lens support frame, and
at least part of the retractable lens group is disposed on the outer peripheral side of the shift lens group when the retractable lens group has retracted to the second position.

21. The lens barrel according to claim 20, wherein
the lens support frame includes a support frame body and a shift frame, the support frame body is movably disposed along the optical axis of the optical system relative to the retractable lens frame, and the shift frame is movably supported by the support frame body in a direction perpendicular to the optical axis of the optical system,
the shift lens group is attached to the shift frame, and
when the retractable lens group has retracted to the second position, the shift frame is disposed at an offset position in which an optical axis of the shift lens group is offset from the optical axis of the optical system.

22. The lens barrel according to claim 21, wherein
when the shift frame is disposed at the offset position, the shift frame comes into contact with the retractable lens frame.

23. The lens barrel according to claim 22, wherein
the support frame body supports the shift frame in a direction perpendicular to the optical axis of the shift lens group,
and the lens support frame further includes a holding member attached to the support frame body to hold the shift frame in a reference position in which the optical axis of the shift lens group substantially coincides with the optical axis of the optical system, and
when the shift frame is disposed at the offset position, the shift frame is pressed against the retractable lens frame by the holding member.

24. The lens barrel according to claim 23, wherein
the support frame body has a guide surface that is inclined relative to the optical axis of the shift lens group, and
when the lens support frame and the retractable lens frame move along the direction of the optical axis, the retractable lens frame guides the shift frame to the offset position by sliding along the inclined guide surface.
